(19) United States
(12) Patent Application Publication
(10) Pub. No.: US 2009/0172983 A1
(43) Pub. Date: Jul. 9, 2009

(54) Display Framing Systems And Related Methods

(75) Inventor: Donald R. Curtis, Thornton, CO (US)

Correspondence Address: LATHROP & GAGE LLP, 4845 PEARL EAST CIRCLE, SUITE 201, BOULDER, CO, 80301, US

(73) Assignee: LIGHTED PROMOTIONS, INC., Thornton, CO (US)

(21) Appl. No.: 12/405,012

(22) Filed: Mar. 16, 2009

Related U.S. Application Data
(63) Continuation-in-part of application No. 11/431,479, filed on May 10, 2006.
(60) Provisional application No. 60/679,544, filed on May 10, 2005.

(51) Int. Cl. G09F 13/04; G09F 13/00; G09F 21/04

(52) U.S. Cl. 40/564; 40/541; 40/591

(57) ABSTRACT

A display framing method includes assembling a backing panel, a two-dimensional light emitting device, one or more spacers and a protective panel, to form a display frame. The backing panel supports the light emitting device; the spacers define a space between the light emitting device and the protective panel. The method also includes sealing all but one unsealed edge adjoining the space, allowing access to the space. A display framing system includes a backing panel that supports a two-dimensional light emitting device, a protective panel, and one or more spacers that define a space between the light emitting device and the protective panel. The light emitting device, the backing panel, and the protective panel align to form a plurality of edges. All but one of the edges are sealed with one or more sealants such that advertising material may be inserted into the space through the unsealed edge.

### RELATED APPLICATIONS

This application is a continuation-in-part of U.S. application Ser. No. 11/431,479, filed May 10, 2006, which claims priority to U.S. Provisional Application Ser. No. 60/679,544, filed May 10, 2005. Both of the aforementioned patent applications are incorporated herein by reference.

### BACKGROUND

Many existing mobile advertising systems utilize tensioning frames that stretch a canvas over the lateral side of a tractor trailer. Other advertising systems simply paint displays directly on the vehicle or apply them as adhesive panels to the vehicle surface. All of these display methods suffer drawbacks. Signs attached to the lateral sides of trucks are exposed to high winds and they are usually viewed for a very short period of time by occupants of a passing vehicle. Advertising exposure is additionally limited to daylight hours as headlight illumination is typically insufficient for adequate viewing at night. From a mechanical point of view, tensioning systems require complex and costly frames with specialized clamps, rails, tensioners and bungee cords. The systems are also prone to mechanical failure and weather-related deterioration that could lead to loss of life and/or property. Adhesive systems and painting are somewhat safer in transit, but removal and replacement of signage can be a troublesome, time consuming and chemically-intensive process.

### SUMMARY

In one embodiment a display framing system includes four edges disposed on the periphery of and substantially perpendicular to a back surface, the four edges include an outside edge and an inside edge, where the depth of the outside edge is less than the depth of the inside edge. A front surface is disposed planar to the back surface and includes an opening for placement of a sign therein.

In one embodiment a method of displaying a sign includes providing a framing system having four edges disposed on the periphery of and substantially perpendicular to a back surface, the four edges include an outside edge and an inside edge, where the depth of the outside edge is less than the depth of the inside edge, and a front surface is disposed planar to the back surface, the front surface includes an opening for placement of a sign therein. The method includes inserting a sign into the opening of the front surface.

In one embodiment, a method of displaying a sign includes providing on a rear door of a tractor trailer a framing system having a back surface, four edges disposed on the periphery of and substantially perpendicular to the back surface, the four edges include an outside edge and an inside edge, where the depth of the outside edge is less than the depth of the inside edge, and a front surface disposed planar to the back surface, the front surface includes an opening for placement of a sign therein. The method includes inserting a sign into the opening of the front surface.

In one embodiment, a display framing method includes the steps of securing a light emitting device on an aluminum sheet; fastening a first protective panel over the light emitting device, and caulking at least three edges of a first assembly formed by the light emitting device, the aluminum sheet and the first panel. Spacing adhesive is applied along at least three upper sides of the first protective panel, and a second panel secured to the spacing adhesive and over the first protective panel. Caulking is applied between the first panel and the second panel along at least three edges corresponding to the at least three upper sides. Advertising material is inserted into a space formed by the spacing adhesive, between the first and second panels, to form a final display assembly.

In one embodiment, a display framing system includes an aluminum sheet; a two-dimensional light emitting device mounted with a top surface of the aluminum sheet, and a first protective panel mounted with a top surface of the light emitting device, via a first adhesive. A second adhesive is applied to a top surface of the first protective panel, along all but one side of the first protective panel. A second protective panel is mounted with the first protective panel via the second adhesive; the second adhesive maintaining a space between the first protective panel and the second protective panel, the one side providing an opening into the space.

In one embodiment, a display framing system includes a segmented display with first and second display sections and a separation therebetween. The separation includes a material joining the first and second sections. Fasteners mounting the first display section with an upper panel of a roll-up vehicle door, and the second display section with a lower panel of a roll-up vehicle door. Hardware secures the first and second display sections with the upper and lower panels.

In one embodiment, a display framing system includes a two-dimensional light emitting device and a panel wrapped at least partially around the light emitting device, to form an advertising space between a front side of the light emitting device and the panel.

In one embodiment, a display framing method includes heating a substantially transparent protective panel and bending the panel to form an enclosure. A light emitting device is mounted with the panel, within the enclosure, and the panel is sealed along at least one first open panel edge. An advertisement is inserted into the enclosure, from a second open panel edge, and the second open panel edge is sealed to waterproof the enclosure.

In one embodiment, a display framing method includes placing a light emitting device face-down on a protective panel and bending the protective panel around the light emitting device, leaving a back opening at a back surface of the light emitting device and two open edges at opposing sides of the light emitting device. The back opening is sealed, the opposing sides of the light emitting device are sealed and the sealed panel is mounted with a vehicle door.

In one embodiment, a display framing method includes assembling a backing panel, a two-dimensional light emitting device, one or more spacers and a protective panel, to form a display frame having a plurality of edges. The backing panel supports the light emitting device, and the one or more spacers define a space between the light emitting device and the protective panel. The method also includes sealing all but one unsealed edge adjoining the space, wherein the unsealed edge allows access to the space.

In one embodiment, a display framing system includes a two-dimensional light emitting device, a backing panel that supports the light emitting device, a protective panel; and one or more spacers. The spacers define a space between the light emitting device and the protective panel. The light emitting device, the backing panel, and the protective panel align to form a plurality of edges. All but an unsealed one of the edges are sealed with one or more sealants such that advertising material may be inserted into the space through the unsealed edge.

### BRIEF DESCRIPTION OF THE FIGURES

FIG. 1 illustrates display framing systems mounted on rear doors of a tractor trailer in accordance with an embodiment.

FIG. 2 illustrates a partial cut-away view of a display framing system mounted on a top posterior portion of a bus in accordance with an embodiment.

FIG. 3 illustrates a partial cut-away view of a display framing system mounted on a bottom posterior portion of a bus in accordance with an embodiment.

FIG. 4 shows a front plan view of one display framing system in accordance with an embodiment.

FIG. 5 shows a front plan view of one display framing system in accordance with an embodiment.

FIGS. 6-7 show top plan views of exemplary display framing systems for clockwise and counter-clockwise opening doors, respectively.

FIG. 8 shows a top plan view of partially and fully opened doors mounted with display framing systems.

FIG. 9 shows a plan view of an exemplary lighting apparatus for a display framing system according to an embodiment.

FIG. 10 shows one display framing system according to FIG. 5 and incorporating a lighting apparatus according to FIG. 9.

FIG. 11 shows a top plan view of a lighting apparatus for a display framing system according to an embodiment.

FIG. 12 shows a cross-sectional view of the lighting apparatus of FIG. 11.

FIG. 13 shows a front plan view of a display framing system incorporating a lighting apparatus according to FIGS. 11 and 12.

FIG. 14 shows a side plan view of the display framing system of FIG. 13.

FIG. 15 is a top exploded view showing components of a display framing system prior to mounting with a vehicle door panel, according to an embodiment.

FIG. 16 is a top view showing the assembled display framing system of FIG. 15, prior to mounting with a vehicle door panel.

FIG. 17 is a side view showing the assembled display framing system of FIG. 16 being secured with the vehicle door panel using hardware and framing materials.

FIG. 18 is a rear view of the assembled display framing system of FIGS. 16 and 17, mounted with a swing-type trailer door.

FIG. 19 is a rear view of an assembled display framing system mounted with a roll-up type trailer door, according to an embodiment.

FIG. 20A is a schematic side view of the display framing system of FIG. 19, showing a flexible connector between display panel sections, mounted with upper and lower panels of the roll-up type trailer door, according to an embodiment.

FIG. 20B is a schematic side view of a display framing system having display panel sections with capped ends, mounted with upper and lower panels of the roll-up type trailer door, according to an embodiment.

FIG. 21A is a schematic side view of a display framing system having partially enclosed, dual protective panels, mounted with the roll-up type trailer door of FIG. 19, according to an embodiment

FIG. 21B is a simplified top view of the system of FIG. 21A.

FIG. 21C is a cut away, advertising-side view of the system of FIGS. 21A and 21B.

FIG. 22A is a side view of a display framing system, according to an embodiment.

FIG. 22B is a cross-sectional top view of the display framing system of FIG. 22A.

FIG. 23A is a simplified, exterior front view of a trailer, showing exemplary wiring for a display framing system.

FIG. 23B is a top view looking down into the trailer of FIG. 23A at the exemplary wiring of FIG. 23A.

FIG. 23C is a top view looking down into the trailer of FIGS. 23A and 23B, showing exemplary wiring support.

FIG. 23D is a side perspective view of the trailer of FIGS. 23A-23C, showing further wiring detail and illustrating a roll-up trailer door in a closed position.

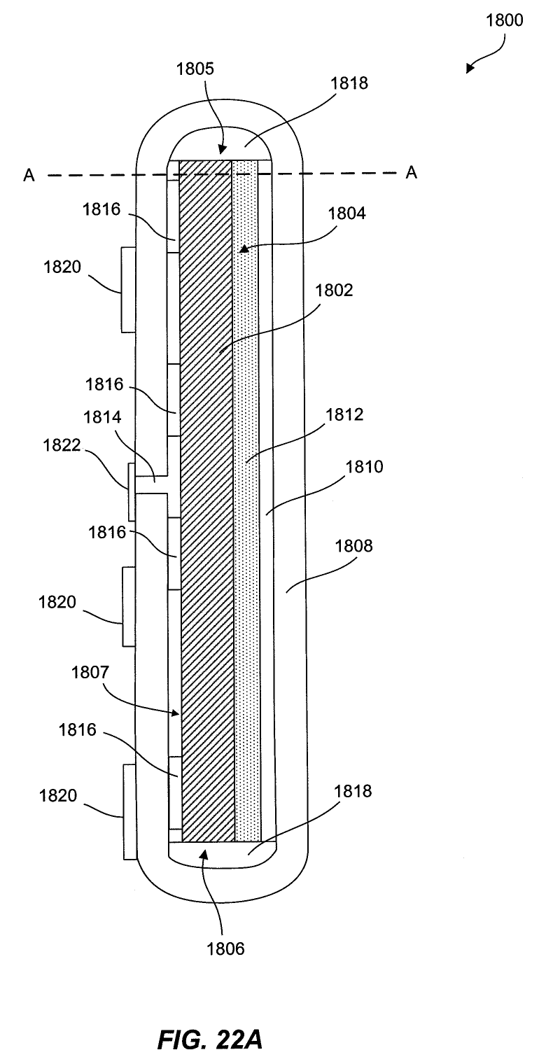

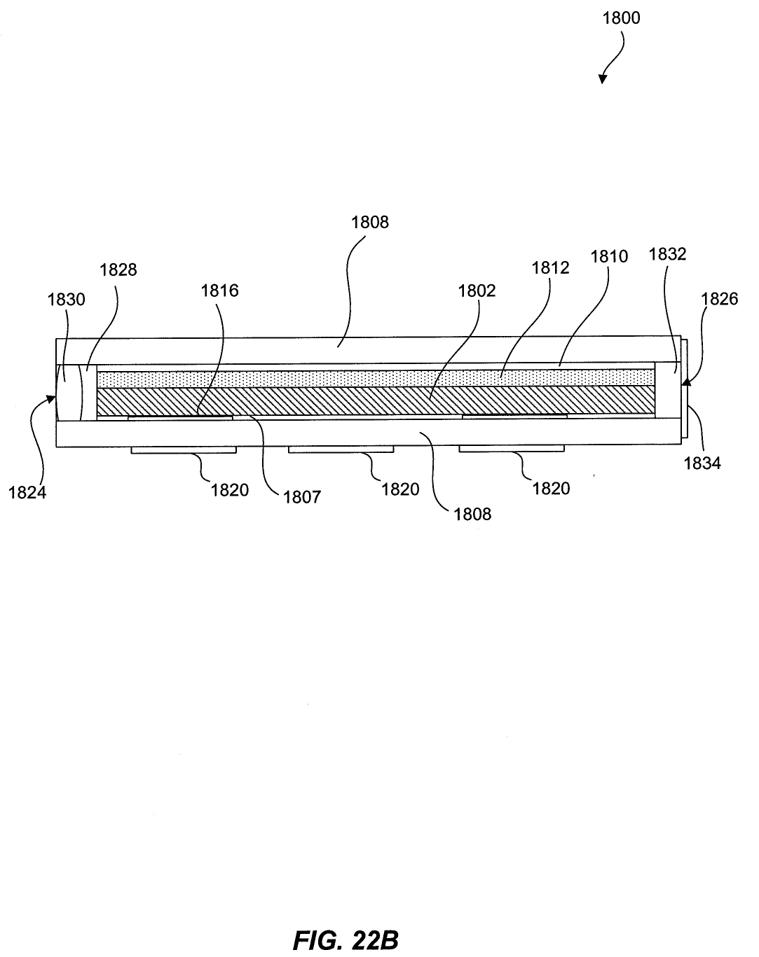

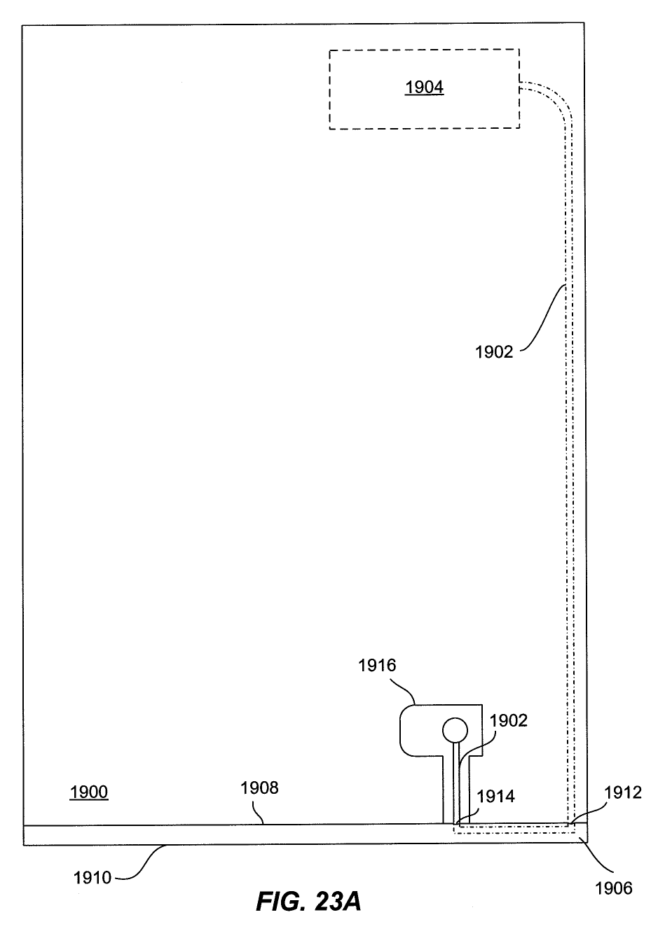

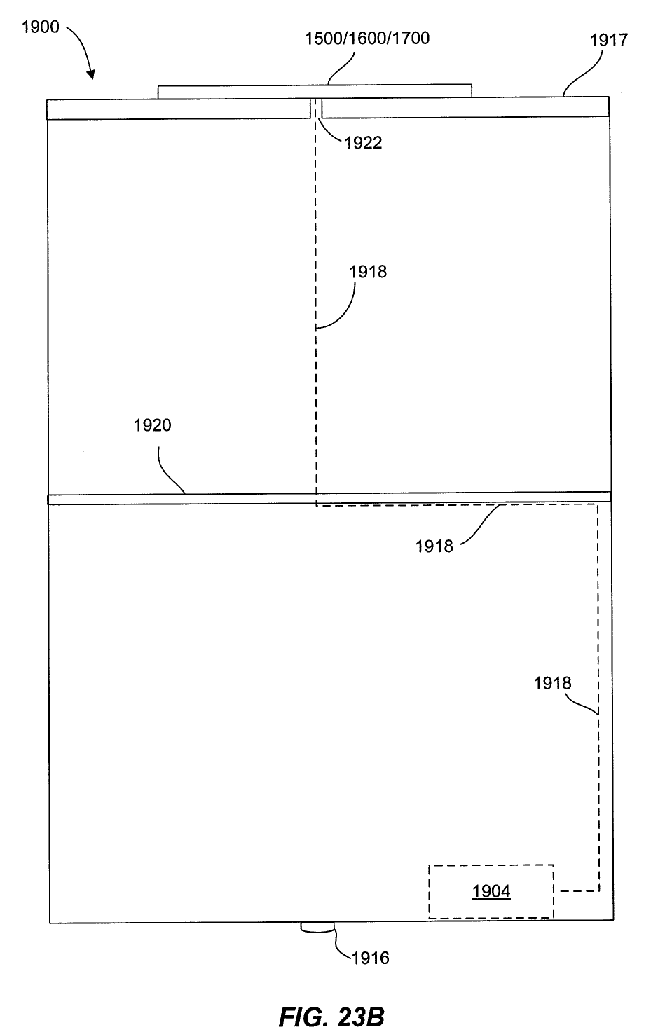

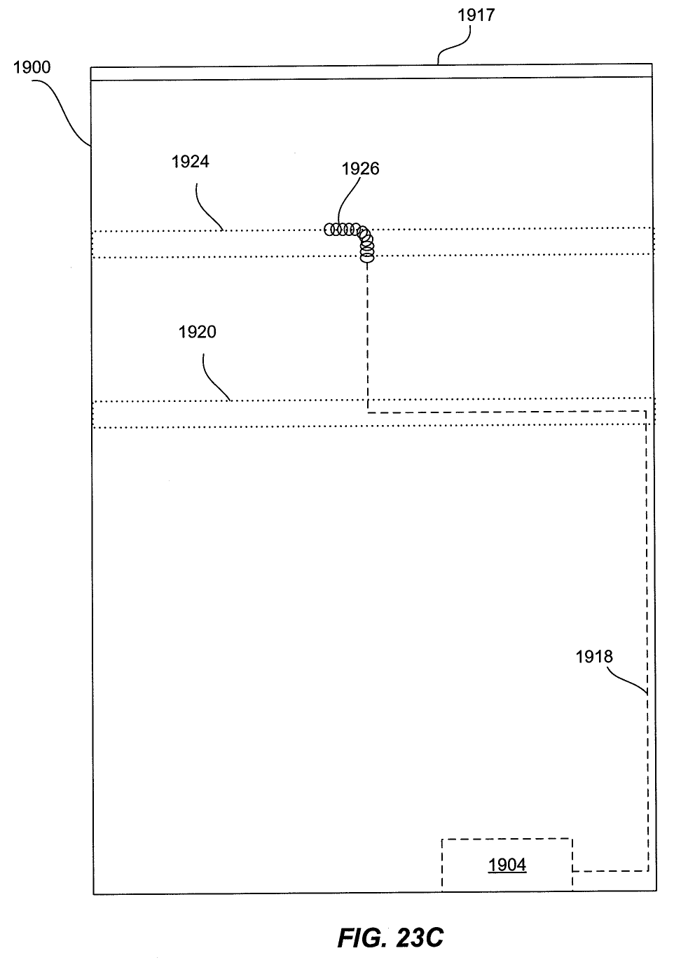

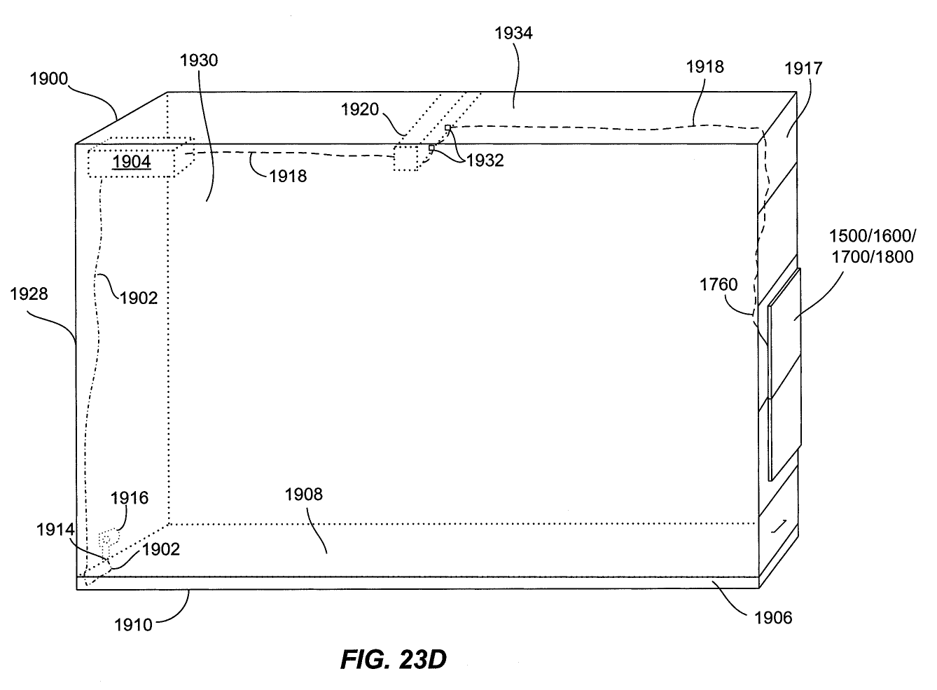

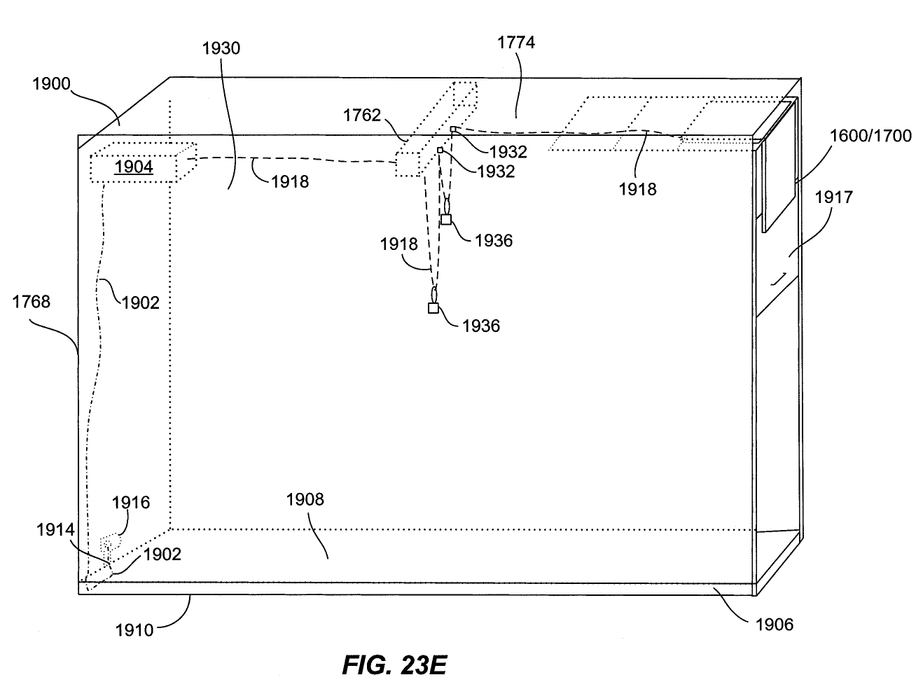

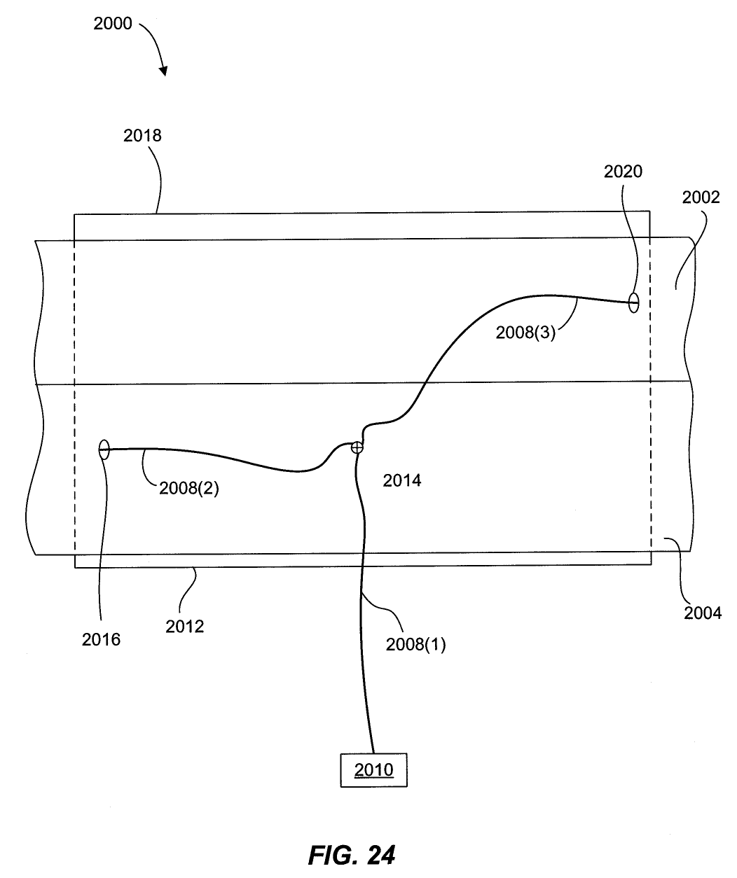

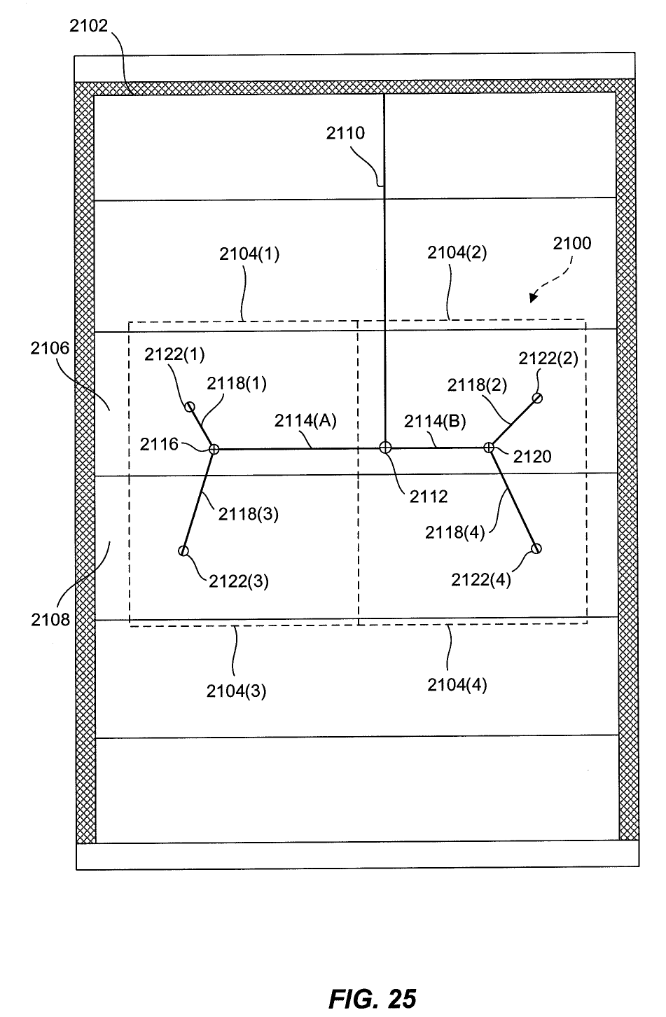

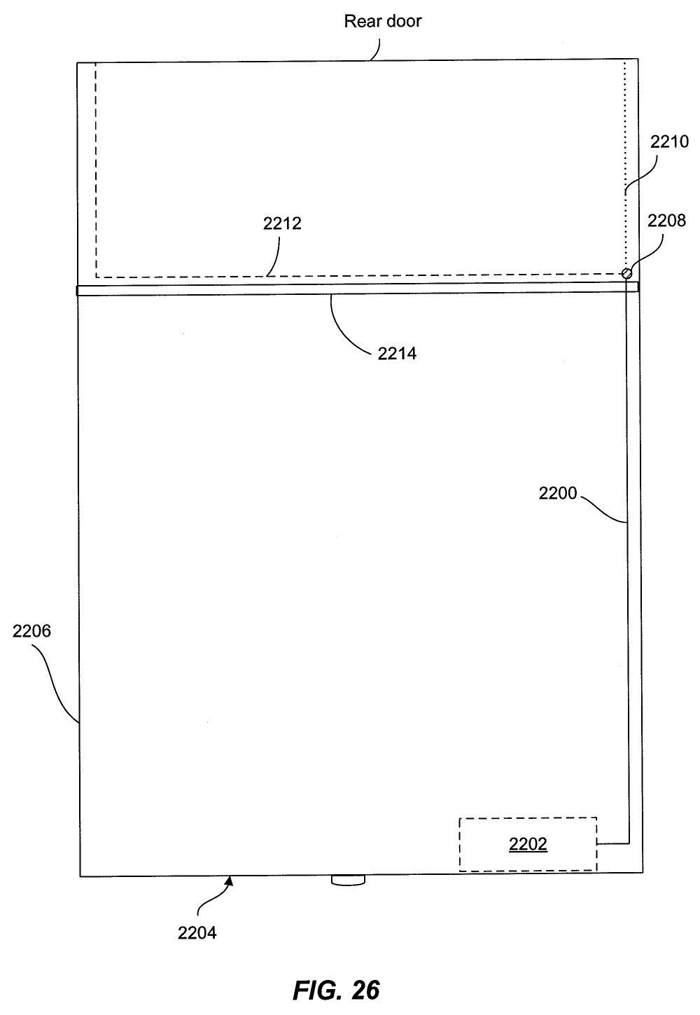

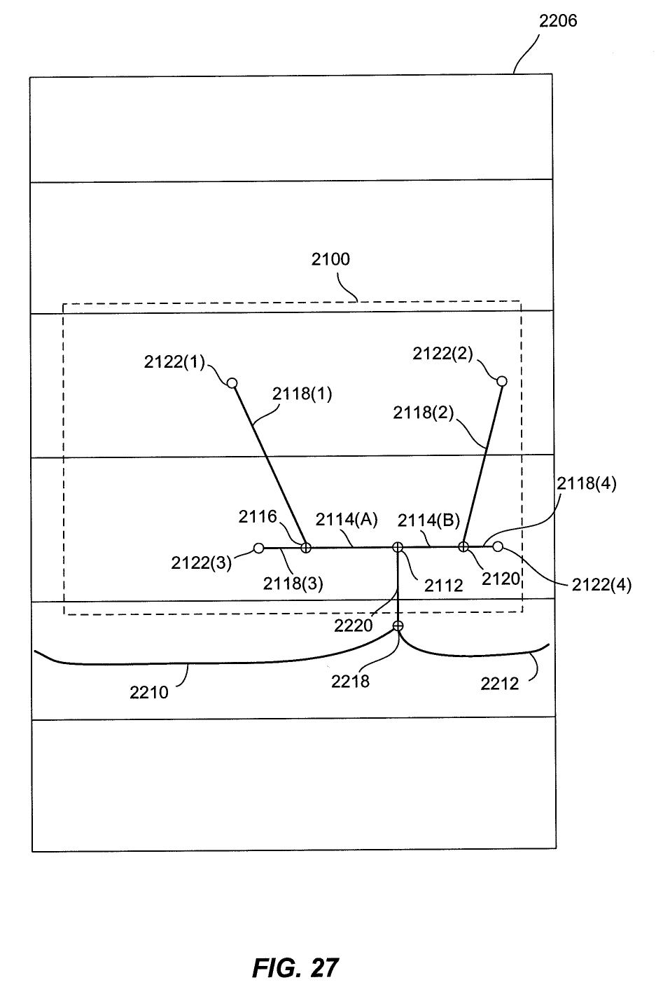

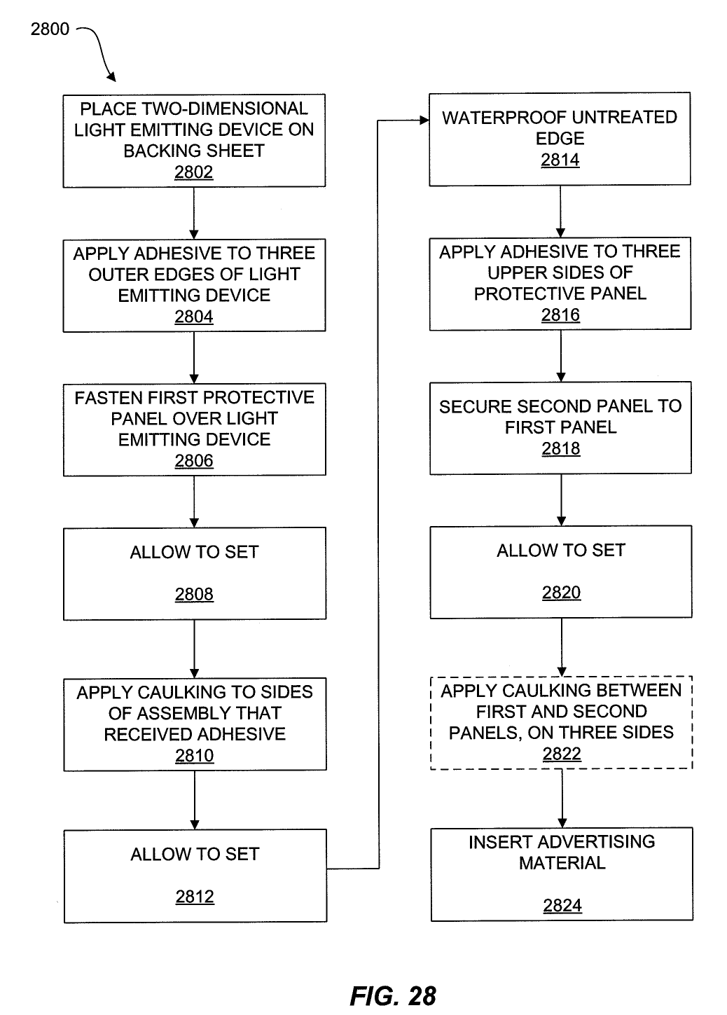

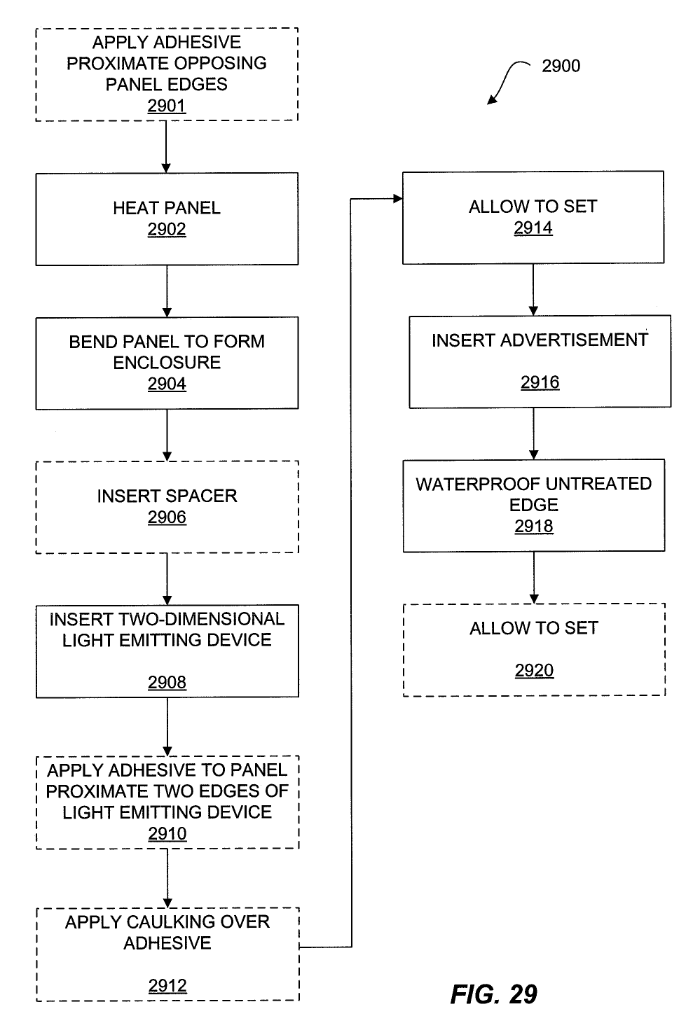

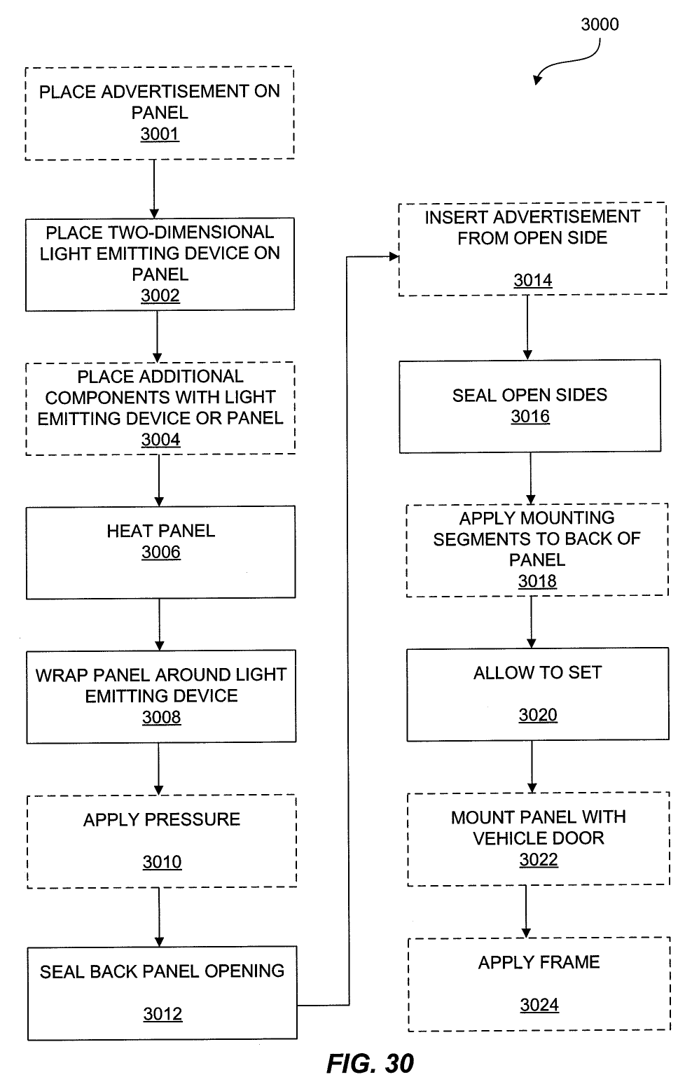

FIG. 22E is a side perspective view of the trailer of FIGS. 23A-23D, showing the roll-up door in an open position.

FIG. 24 is a simplified rear view showing wiring for a display framing system, according to an embodiment.

FIG. 25 is a schematic rear view of an inner aspect of a roll-up trailer door bearing a display framing system, according to an embodiment.

FIGS. 26 and 27 show exemplary wiring configurations for connecting a display framing system with an inverter of a vehicle trailer, in accordance with an embodiment.

FIG. 28 is a flowchart illustrating a display framing method, according to an embodiment.

FIG. 29 is a flowchart illustrating another display framing method, according to an embodiment.

FIG. 30 is a flowchart illustrating a further display framing method, according to an embodiment.

### DETAILED DESCRIPTION

The present disclosure relates to display framing systems and, more specifically, to systems that are mountable on doors and/or vehicles, and optionally lit. A mobile display framing system, such as described herein, may be advantageously located on the back of a tractor trailer or bus, where it can be kept out of the wind and where following vehicles can view an advertisement disposed therein for a considerable length of time. The display may be lit, especially at night, to increase the effective advertising time and thus the number of people viewing the advertisement.

In one embodiment, a display framing system may be used to secure a Plexiglas® sign to a surface of a door (e.g., the rear door of a tractor trailer); though it is nonetheless understood that the present systems may be used with any interior or exterior door, gate, stall or other hinged body, for example. A frame assembly retains a semi-flexible sheet-like panel or sign within a substantially rectangular frame. The frame is adapted to contain peripheral edges of the sign within an opening in the front surface of the frame system. The frame is further designed with a canted orientation that allows doors to be opened without interference from or damage to the frame system or vehicle.

In another embodiment, a display framing system may be mounted on an unhinged body, e.g., a posterior portion of a bus. A canted orientation of the display framing system may allow a sign within the display framing system to be angled for improved viewing.

If a sign contained within the framing system is lit, lighting provides evenly distributed light by use of reflector panels. Power for the lighting may be provided by an independent battery or by the power system of a vehicle. It will be understood that converters and/or inverters that form part of the existing electrical system of the vehicle may be used to manipulate power for the display framing system. Alternatively, converters and/or inverters may be incorporated into the display framing system.

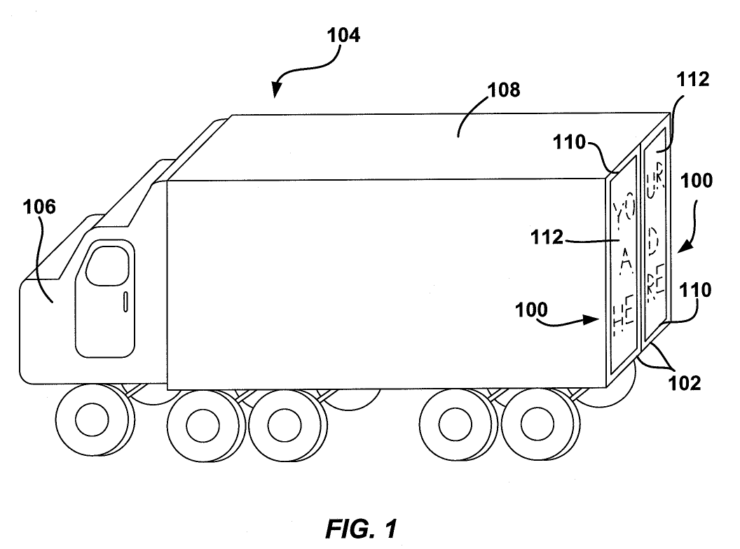

FIG. 1 illustrates two display framing systems 100 mounted on the rear doors 102 of a tractor trailer 104, which includes a motor truck 106 and a semi-trailer 108 rigged thereto. Systems 100 include a frame assembly 110, a sign 112 and, optionally, lighting apparatus (not shown). Each framing system 100 may be fixedly attached to the door of the tractor trailer using hardened steel bolts or other suitable means known in the art.

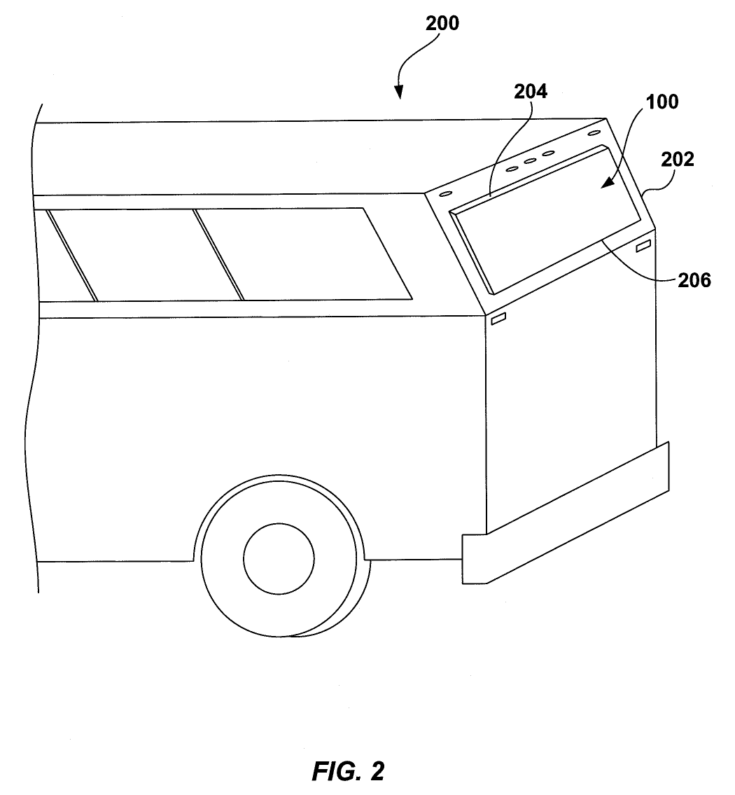

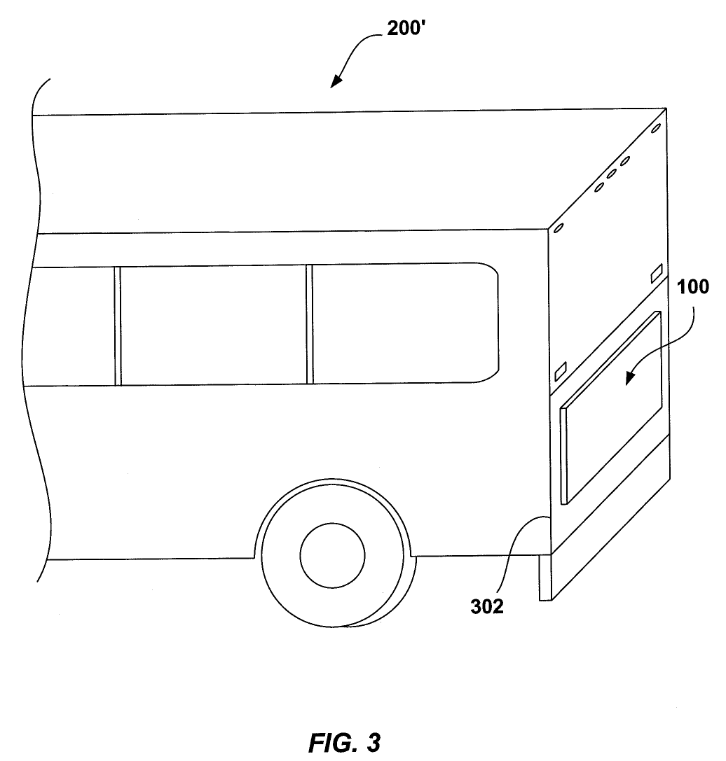

FIGS. 2 and 3 illustrate partial cut-away views of display framing systems 100 mounted to posterior portions of a bus 200. Display framing system 100 of FIG. 2 is positioned on a forwardly angled top portion 202 of bus 200. It may be desirable in such an orientation for top edge 204 of framing system 100 to have a greater depth than bottom edge 206. A downward angle (relative to top portion 202) may, for example, enable better viewing from passenger cars. FIG. 3 illustrates a framing system 100 positioned on vertical portion 302 of bus 200′, where it may or may not be necessary to cant display framing system 100 for better viewing.

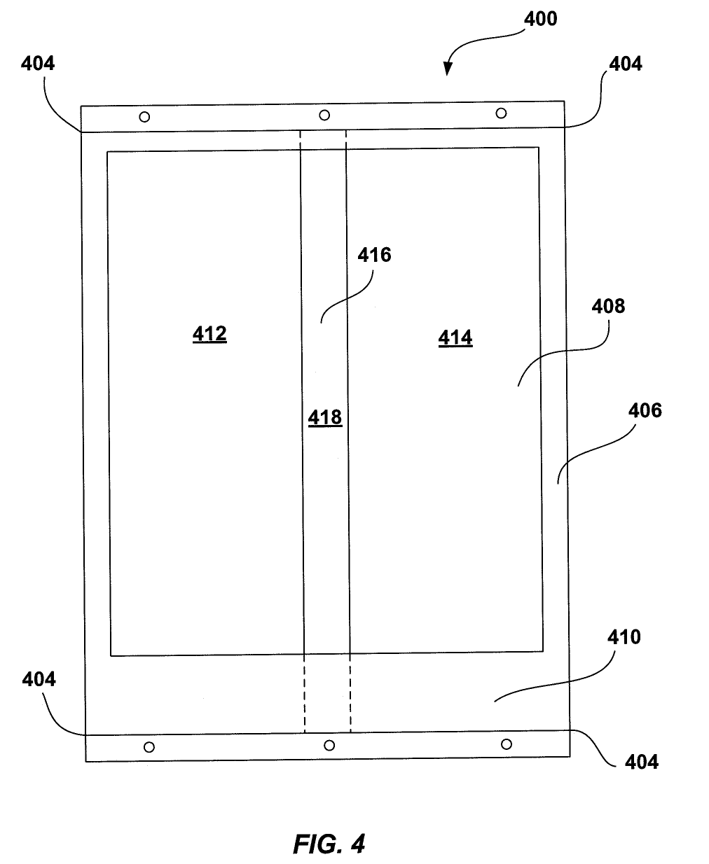

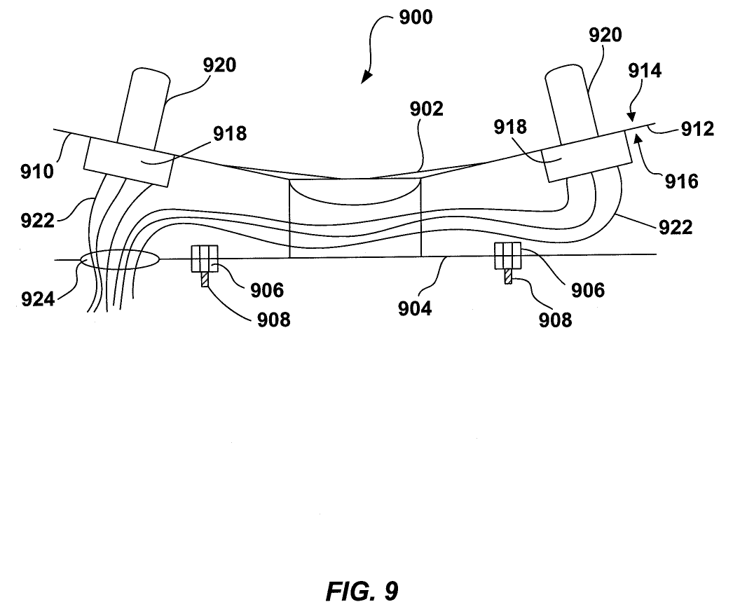

FIG. 4 shows a front plan view of one display framing system 400. System 400 is generally a three-dimensional rectangular frame having a substantially flat and rectangular back surface 418. Back surface 418 may be a pre-existing body (e.g., door 102 of truck 104) to which framing system 400 attaches. Four edges disposed on the periphery of and substantially perpendicular to back surface 418 form approximate right angles at four corners 404 of framing system 400. The edges form a depth of the framing system of about 2-3 inches. A front surface 406 of similar dimension and disposed planar to back surface 418 includes an opening 408 where a sign (not shown) may be inserted. The dimensions of back surface 418 may be approximately 70″×34″ with an opening of approximately 64″×32″ for a framing system used on the rear door of a tractor trailer. In one embodiment, at least one portion 410 of the front surface is of sufficient depth to enclose an optional lighting apparatus (not shown in FIG. 4; see FIGS. 9-14). In the present embodiment, the lighting system portion 410 is shown on the bottom of the sign. However, the lighting system portion 410 may alternatively be located at the top or side of the sign, and more than one lighting apparatus may be included within the framing system. Framing system 400 also includes two longitudinal reflector panels 412, 414 that are angled toward the center 416 of the framing system. Reflector panels 412, 414 may be planar or curved into an approximately parabolic shape. In one embodiment, the reflector panels do not touch, and back surface 418 may be observed in a gap formed there between. The framing system and/or reflector panels may be fabricated from white, powder coated aluminum, polished or unpolished metal, a mirrored material or rigid materials that efficiently reflect light from a lighting system.

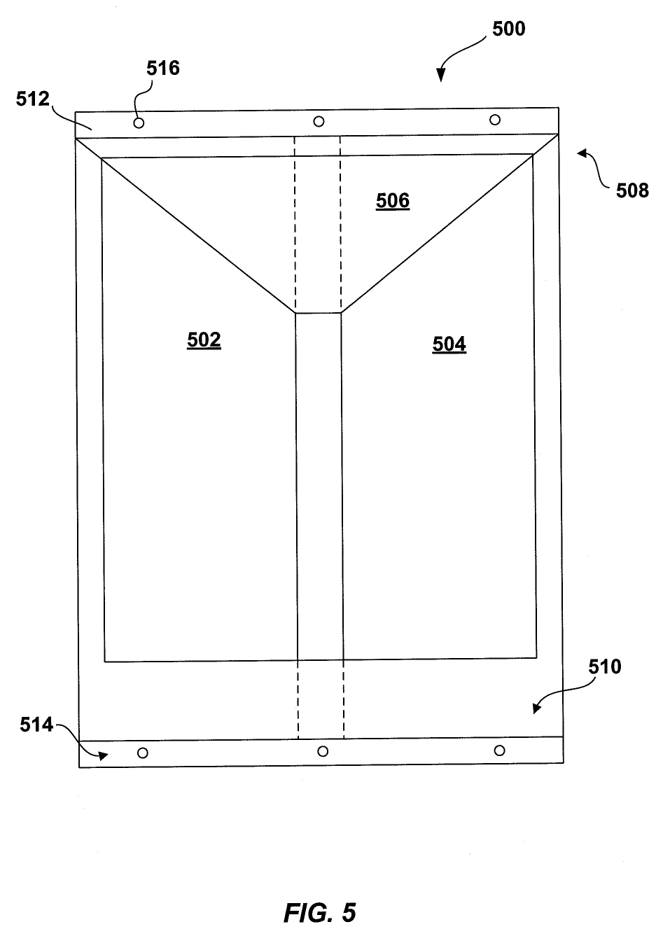

FIG. 5 shows a front plan view of one display framing system 500, which includes three reflector panels 502, 504, 506. Reflector panels 502 and 504 are longitudinal, while reflector panel 506 forms a substantially triangular segment disposed near a top 508 of the framing system 500. Third reflector panel 506 may be desirable when a lighting apparatus is incorporated at a bottom 510 of the framing system. Light emitted upward by the lighting apparatus may be reflected downward and forward by reflector panel 506. Although the present embodiment has been described with reference to three reflector panels, it is contemplated that a framing system 500 may incorporate one or a plurality of reflector panels. A framing system may also include mounting panels 512, 514 forming holes for receiving hardened steel bolts 516, or other suitable securing means.

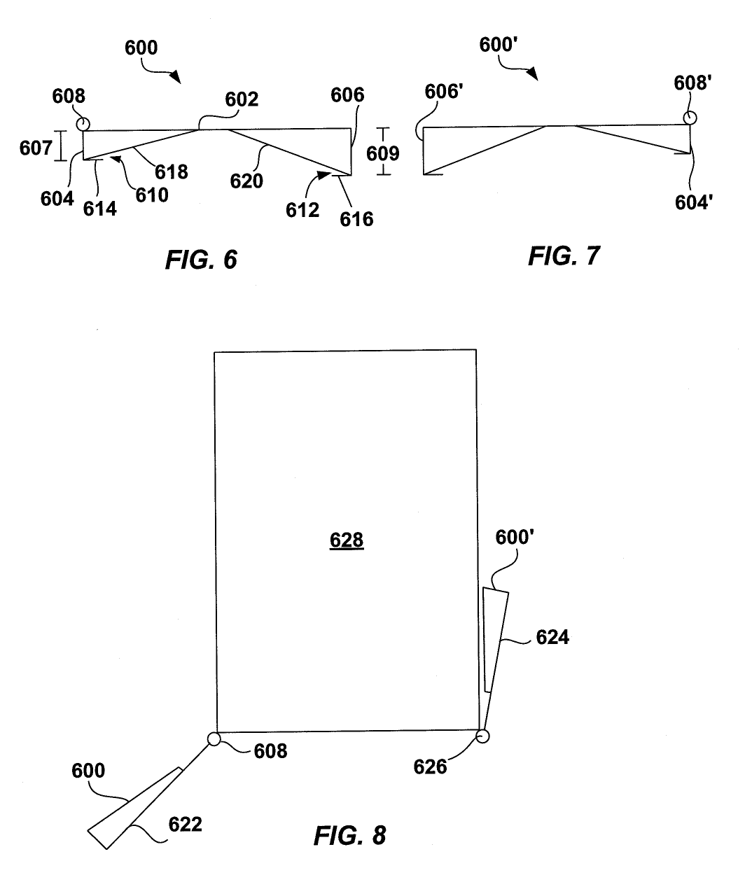

FIGS. 6-7 show top plan views of display framing systems for clockwise and counter-clockwise opening doors, respectively. Referring first to FIG. 6, a back surface 602 is perpendicular to two edges 604, 606 of a framing system 600. The outside edge 604, located nearest a hinge 608, has a depth 607 of about 2″ while the inside edge 606 has a depth 609 of about 3″. Channels 610, 612 are formed between portions of the front surface 614, 616 and longitudinal reflector panels 618, 620 to hold a sign (not shown) in place. A sign may be inserted or removed from channels 610, 612 by slightly bending the sign to secure, or free, at least one edge thereof. Alternatively, a top edge or one or both of side edges 604, 606 of display framing system 600, may open to allow insertion of a sign into framing system 600. In one embodiment, it may be desirable to have the edge(s) lock after the sign has been inserted to prevent theft.

FIG. 7 shows an embodiment of a display framing system 600′ suitable for a counter-clockwise opening door. The inside edge 606′ has a depth of about 3″, while the outside edge 604′ has a depth of about 2″. The canted nature of the framing system allows for opening of vehicle doors without interference from or damage to the framing system or the vehicle. See FIG. 8. Partially and fully opened doors 622, 624 mounted with framing systems 600, 600′ are, for example, attached with hinges 608, 626 to semi-trailer 628. In one embodiment, the corner formed by outside edge 606 and front surface 616 (FIG. 6) may be coated with a protective, cushioning material, such as rubber, to prevent damage to framing system 600 and semi-trailer 628 when door 622 is opened.

FIG. 9 shows a plan view of exemplary lighting apparatus 900 for a display framing system. Lighting apparatus 900 includes a scaffolding 902 with a base plate 904 for mounting to the framing system with nuts 906 and bolts 908 or other means. Scaffolding 902 may also be anchored to the reflector panels using rivets (not shown) to reduce vibrations. The scaffolding 902 further includes extension arms 910, 912 that each have a top surface 914 and a bottom surface 916, with a hole (not shown) therethrough. Transformers 918 may be mounted on bottom surfaces 916 of extension arms 910 and 912 beneath the holes. Light bulbs 920 may be inserted into transformers 918 through the holes so that the light bulbs 920 are disposed above the top surface 914. Wires 922 from transformers 918 may exit the framing system through a rubber grommet 924. Power for lighting apparatus 900 may be supplied by an independent battery or by connection to a vehicle power system, as discussed above.

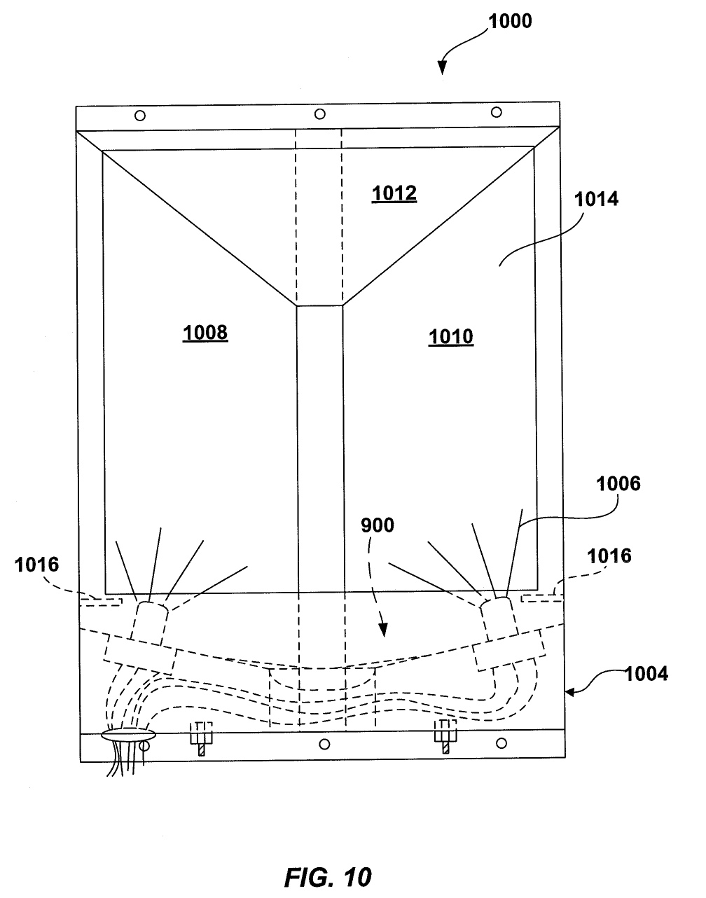

FIG. 10 shows one display framing system 1000 incorporating lighting apparatus 900 according to FIG. 9. Lighting apparatus 900 is disposed in a bottom portion 1004 of framing system 1000 with light 1006 from light bulbs of apparatus 900 radiating upward, as shown. Framing system 1000 may include stoppers 1016 that prevent a sign from resting directly upon lighting system 900. Reflector panels 1008, 1010 and 1012 help to distribute bright and even light through a sign (not shown) inserted in opening 1014.

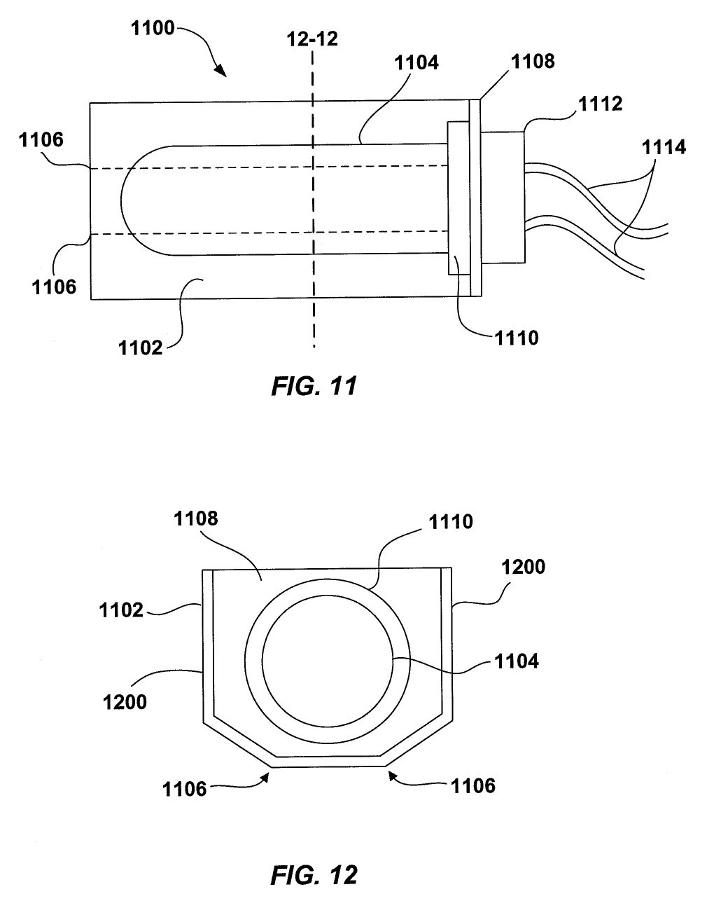

FIG. 11 shows a top plan view of another lighting apparatus 1100, which has a reflector cradle 1102 that is sized and shaped to conform to a light bulb 1104. Reflector cradle 1102 is bent at positions 1106 to effectively surround light bulb 1104 when combined with rear wall 1108 and side walls 1200, which are visible in the cross-sectional view taken along plane 12-12, FIG. 12. Light bulb 1104 has a base 1110 that attaches to transformer 1112 through rear wall 1108. Wires 1114 supply power from a battery or vehicle power system to light bulb 1104.

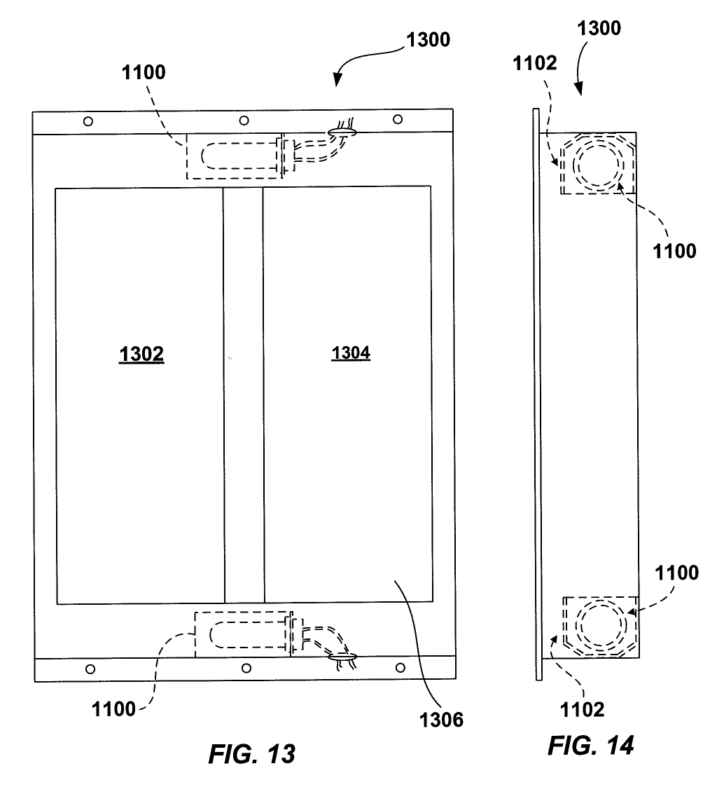

FIG. 13 shows a front plan view of a display framing system 1300 incorporating lighting apparatus 1100. Framing system 1300 includes reflector panels 1302, 1304 as well as two instances of lighting apparatus 1100. FIG. 14 is a side plan view of display framing system 1300, where it can be observed that reflector cradles 1102 direct light toward opening 1306.

Additional embodiments of the lighting apparatus are contemplated; for example, the lighting apparatus may incorporate one or a plurality of light bulbs or LEDs, wired in series or parallel, emitting various wavelengths of radiation at constant, pulsed or sequential intervals. The plurality of light bulbs or LEDs may be positioned around the periphery of opening 1014 (FIG. 10) or 1306 (FIG. 13), for example.

In one embodiment, a two-dimensional light emitting device may be disposed on one or more reflector panels or back surface 418 to provide backlighting for signs inserted into opening 1014, 1306. The term “two-dimensional light emitting device” herein denotes a device that produces and emits light uniformly from all points on a two-dimensional surface thereof, and specifically excludes arrangements that produce light from one or more discrete sources and reflect, refract or diffuse the light to provide two dimensional illumination. A suitable two-dimensional light emitting device is manufactured by CeeLite™ of Lansdale, Pa. Two-dimensional light emitting devices may be advantageous in display framing systems at least because (1) they are often characterized by very uniform light emission from the two-dimensional surface (e.g., they tend not to present “bright” and “dark” spots); (2) they may be somewhat flexible, and thus forgiving of mechanical stress during assembly, mounting and/or use; and (3) they may be very thin (e.g., ¼ inch or less), enabling their integration into display framing systems that are likewise thin (e.g., less than one inch or less than ½ inch total thickness of the framing system).

Each display framing system may include a single lighting apparatus, or more than one lighting apparatus where the multiple apparatus are either of the same type or different types in relation to one another. Additionally, the lighting apparatus may be turned on/off using manual switches, timing devices or light sensing devices that are known in the art.

A sign suitable for use with a display framing system may be made of a plastic polymer, such as Plexiglas® or Lexan®, and/or other materials that are semi-flexible, resistant to shock, vibration and impact and at least partially transparent to light.

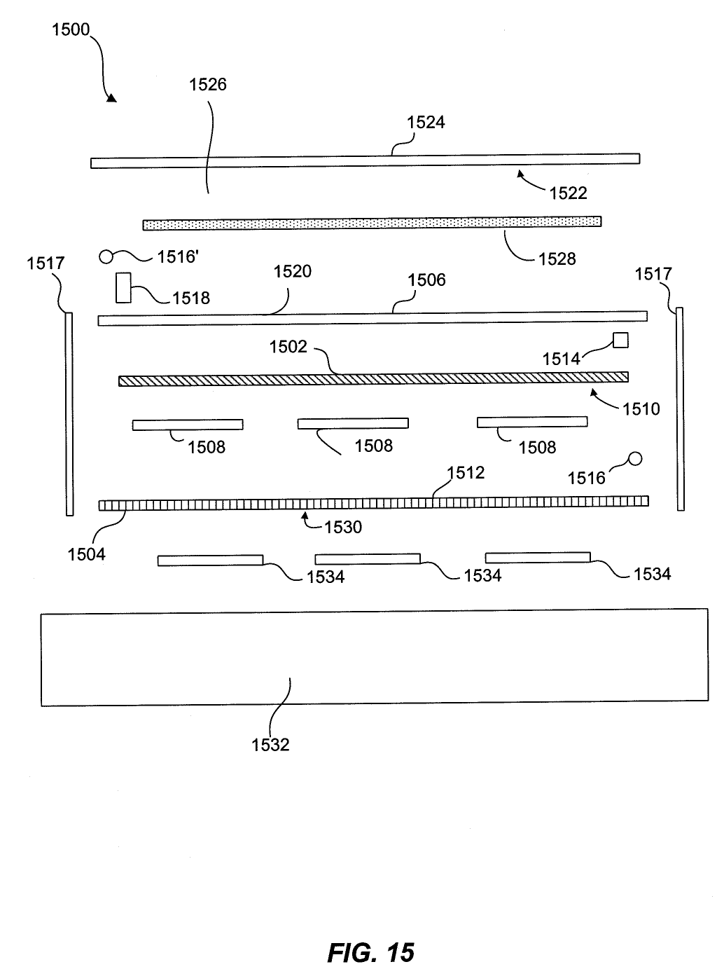

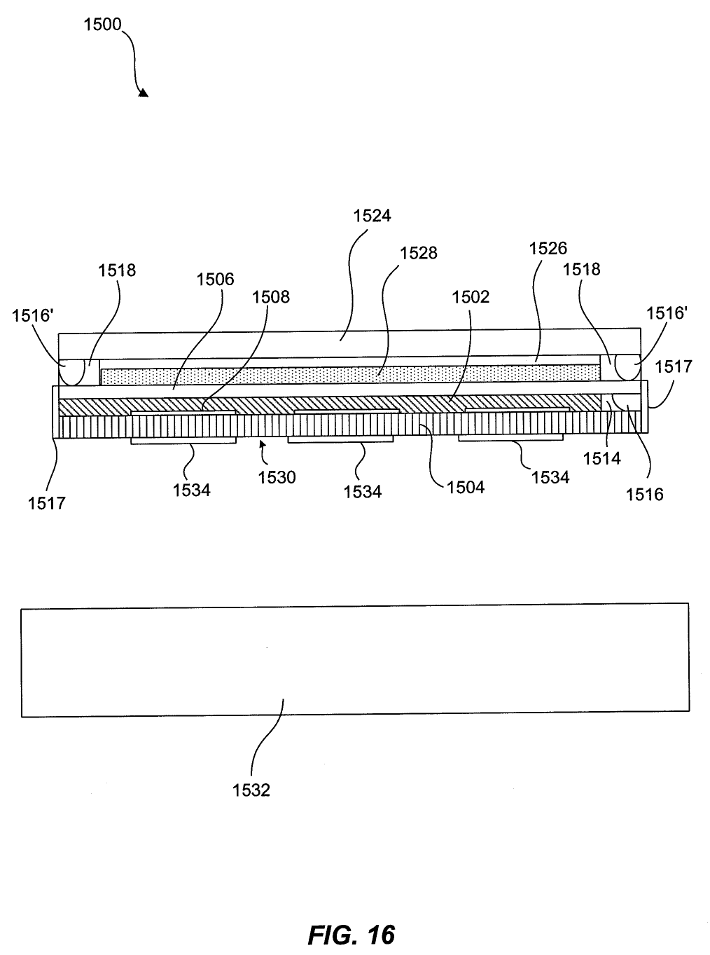

FIGS. 15 and 16 are top exploded and assembled views, respectively (i.e., looking down from atop a vehicle) illustrating one embodiment of a display framing system 1500, respectively, with a vehicle panel. FIGS. 15 and 16 are not drawn to scale. System 1500 incorporates a two-dimensional light emitting device 1502, such as the CeeLite™ device noted above. Light emitting device 1502 is backed by a backing panel 1504 (that may be painted or unpainted and formed, for example, of aluminum) and covered with a transparent or translucent (e.g., frosted) protective panel 1506. Panel 1506 is for example a clear, tinted or frosted white Lexan® panel or a clear Plexiglas® sheet; however, other suitably transparent protective coverings may also be used. In one embodiment, device 1502 is smaller than backing panel 1504 and/or protective panel 1506, such that a border of ½″ or less of backing panel 1504 and/or panel 1506 surrounds device 1502 when device 1502 is mounted with backing panel 1504 and panel 1506. Also, in one embodiment an entire thickness of framing system 1500 is one inch or less, particularly ½ inch or less, to facilitate mounting of framing system 1500 on a vehicle without interfering with operation of the vehicle (for example, so that a truck including system 1500 may be backed up to a fixed surface or object without fear of damaging system 1500).

Device 1502 may be secured with backing panel 1504 via one or more fasteners 1508. Fasteners 1508 may be hook and loop fasteners such as Velcro®, or adhesives such as double-sided tape. The term “double-sided tape” herein denotes tape with adhesive on both sides thereof (e.g., not merely tape that has two physical sides). Fasteners 1508 hold device 1502 in place during assembly of system 1500. Alternately or additionally, a back surface 1510 of device 1502 and a front surface 1512 of backing panel 1504 (shown in FIG. 15) include lock-and-key features that are snapped, slid, pressed or otherwise engaged together to secure device 1502 to backing panel 1504.

Adhesive 1514 secures protective panel 1506 to device 1502, such that device 1502 is sandwiched between backing panel 1504 and panel 1506. Adhesive 1514 is for example ¼″ to ½″ weatherproof and moisture proof double-sided tape, applied to some or all edges of device 1502. In one embodiment, adhesive 1514 is a high density acrylic foam tape layered with acrylic-type adhesive on either side, having a thickness of about 1.14 mm and a peel adhesion of 11 pounds per inch or more, after a 72 hour curing period. Bron tape type BT-3849 may serve as adhesive 1514. Caulking 1516 may be applied between backing panel 1504 and protective panel 1506, from adhesive 1514 out, along all edges, in order to completely seal device 1502 between panel 1506 and backing panel 1504. Caulking 1516 aids in preventing water or debris from entering the space between backing panel 1504 and protective panel 1506, and/or contacting device 1502. For ease of illustration, adhesive 1514 and caulking 1516 are shown only along select edges of device 1502 in FIGS. 15-17.

Single-sided, waterproof tape 1517, or another adhesive, may be applied to one or more edges of assembled backing panel 1504, device 1502 and protective panel 1506, to further seal system 1500 against moisture, dirt and debris. A spacer 1518 that may include adhesive surfaces, separates a top surface 1520 of protective panel 1506 from a bottom surface 1522 of a protective panel 1524 (shown in FIG. 15), on three sides. For clarity of illustration, spacer 1518 and caulking 1516 are shown only along select sides in FIGS. 15-17. Spacer 1518 is for example a ¼ to ½″ double-sided tape or other adhesive, separating panels 1506, 1524 by an open space 1526 that is sufficient to allow insertion of an advertisement 1528 between panels 1506, 1524. Advertisement 1528 is for example an illustration, text advertising a product or service, safety information or an informational display. Advertisement 1528 is at least partially translucent such that when illuminated, device 1502 back-lights advertisement 1528 so that it may be seen at night or in dim conditions.

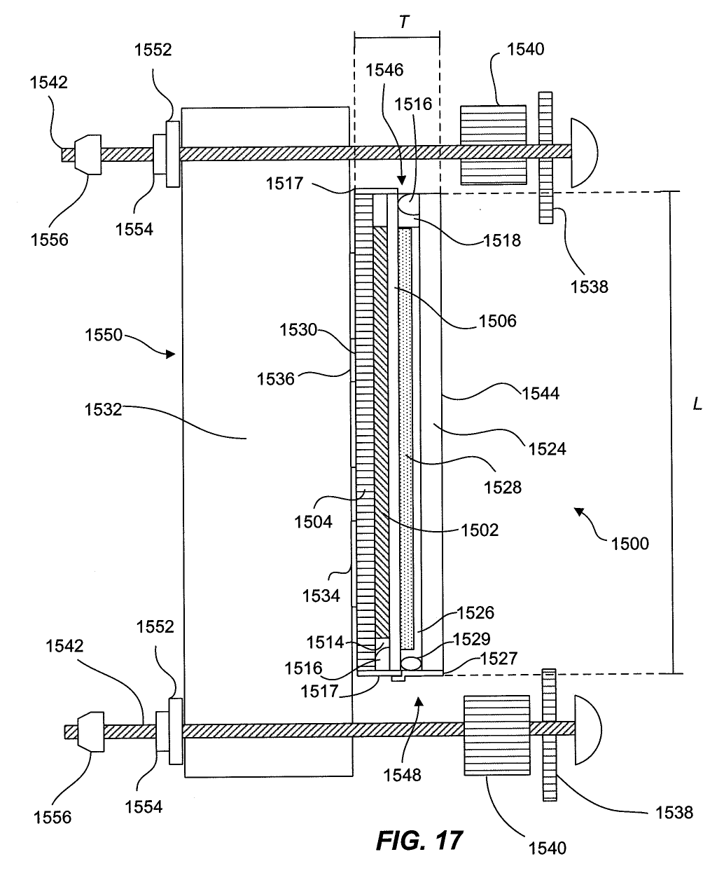

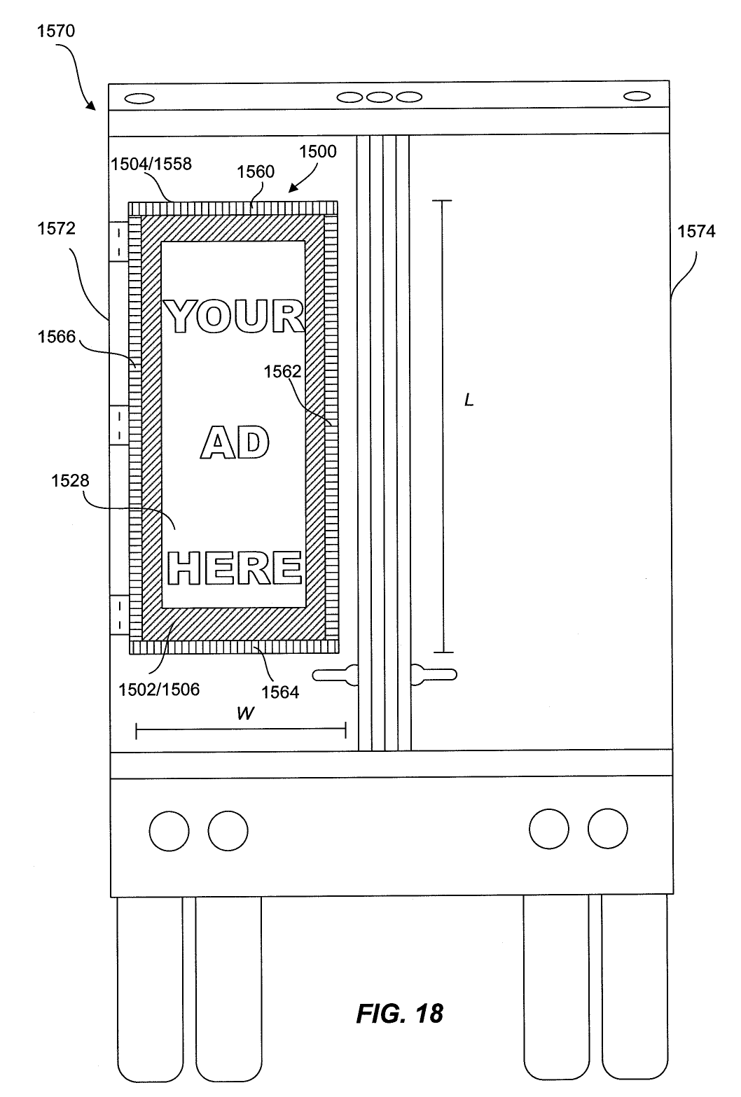

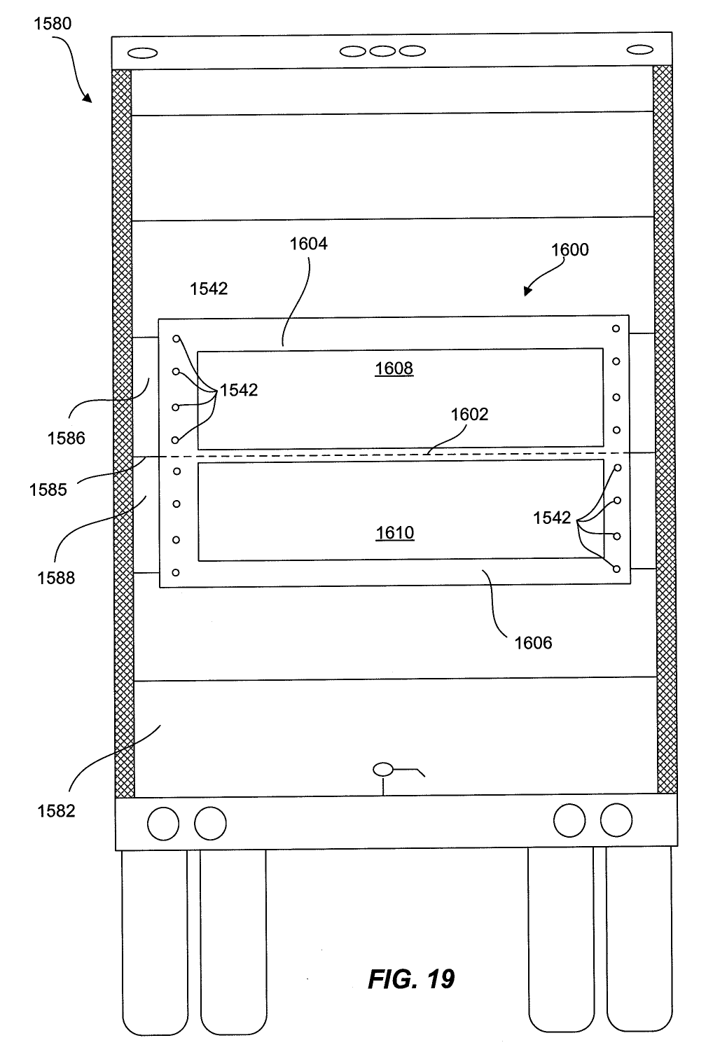

Open space 1526 is for example maintained by the thickness of spacer 1518 and/or caulking 1516′ between panels 1506, 1524. Caulking 1516′ is applied between panels 1506, 1524 on some or all sides fastened with spacer 1518. In one embodiment, spacer 1518 and caulking 1516′ are not applied to the bottom side of device 1500, to allow for insertion of advertising material (e.g., advertisement 1528) from the bottom of the display framing system. Advertisement 1528 is positioned over device 1502, such that device 1502 backlights the advertisement when powered. As shown in FIG. 17, Additional tape or adhesive 1527 (e.g., a strip of single-sided, clear tape, not shown) seals advertising material between panels 1506 and 1524 once advertising material 1528 is in place. This additional tape or adhesive 1527, spacer 1518 and caulking 1516 cooperatively form a watertight open space 1526 housing advertisement 1528. Seals (see, e.g., seals 1529, FIG. 17) may also be fitted with display framing system 1500, as a substitute for, or in addition to, additional tape 1527, to further waterproof space 1526. Seals 1529 are for example rubber or silicone.

System 1500 allows for an easily changeable display. Additional tape 1527 and/or seals 1529 need only be removed, and one advertisement 1528 swapped for another, in order to change an appearance of system 1500. In another example, where a more permanent display is desired, panels 1506 and 1524 may be sealed on all sides with spacer 1518 and caulking 1516′, after advertisement 1528 is positioned on panel 1506.

A back surface 1530 of backing panel 1504 is secured to a vehicle panel 1532 via one or more fasteners 1534. Vehicle panel 1532 is for example a panel (e.g., a side panel or a rear door panel, among other possibilities) of a tractor-trailer, semi trailer, van, bus, straight truck, passenger van, taxi or other vehicle used to transport freight or persons. Like fasteners 1508, fasteners 1534 may be Velcro® or other hook and loop fasteners, adhesives or other fasteners, such as hooks configured to fit with horizontal panel sections of a roll-up type trailer door. Fasteners 1534 hold system 1500 in place on door panel 1532 during installation (described below with respect to FIG. 18).

As illustrated in FIG. 17 (not drawn to scale), assembled system 1500 may be mounted with an outer surface 1536 of vehicle panel 1532 via framing 1538, 1540 (made, for example, of aluminum) that is secured to system 1500 and panel 1532 with steel or aluminum carriage bolts 1542. When carriage bolts 1542 are tightened, framing 1538 contacts an outer surface 1544 of panel 1524, pressing system 1500 to vehicle panel 1532. Framing 1540 is sized to approximately match the overall thickness (T) of system 1500, in order to provide a smooth transition between framing 1540 and system 1500 and prevent tilt or bending of framing 1538 when carriage bolts 1542 are tightened. In one aspect, carriage bolts are placed at approximately every eight inches along system 1500.

In one embodiment, one or more carriage bolts 1542 secure a strip of framing 1538 along a top edge 1546 of system 1500. One or more carriage bolts 1542 secure a strip of framing 1538 along a bottom edge 1548. Framing 1538 is for example a metal (e.g., aluminum) strip or strips that span a width of system 1500. Exemplary system width W is shown in FIG. 18. When carriage bolts 1542 are tightened, strips of framing 1538 secure against the sides of system 1500, further protecting the interior of system 1500 (e.g., device 1502, panels 1506, 1524, space 1526, etc.) from weather, moisture and/or debris. Framing 1540 may also be sized to span the width of system 1500, to further guard against entry of contaminants or moisture.

In another aspect, carriage bolts 1542 and framing 1538, 1540 may also, or alternately, secure system 1500 to vehicle panel 1532 via left and right sides of system 1500 (not shown). Where left/right attachment is used, framing 1540 and/or 1538 may be sized to approximately match the length (L) of system 1500, and pairs of carriage bolts 1542 may be used to secure framing 1538, 1540 proximate left and right corners of system 1500. Exemplary system length L is also shown in FIG. 18.

As noted above, three sides of system 1500 may be sealed with adhesive 1514, spacer 1518 (e.g., double-sided tape) and caulking 1516. Thus, the side of system 1500 that lacks adhesive 1514, spacer 1518 and caulking 1516 may be protected by framing 1538, 1540, when system 1500 is secured to vehicle panel 1532, in lieu of or in addition to adhesive 17 (i.e., clear, waterproof assembly tape), to create a moisture proof enclosure for light emitting device 1502 and any advertisement 1528 mounted therewith. See above description of FIGS. 15 and 16.

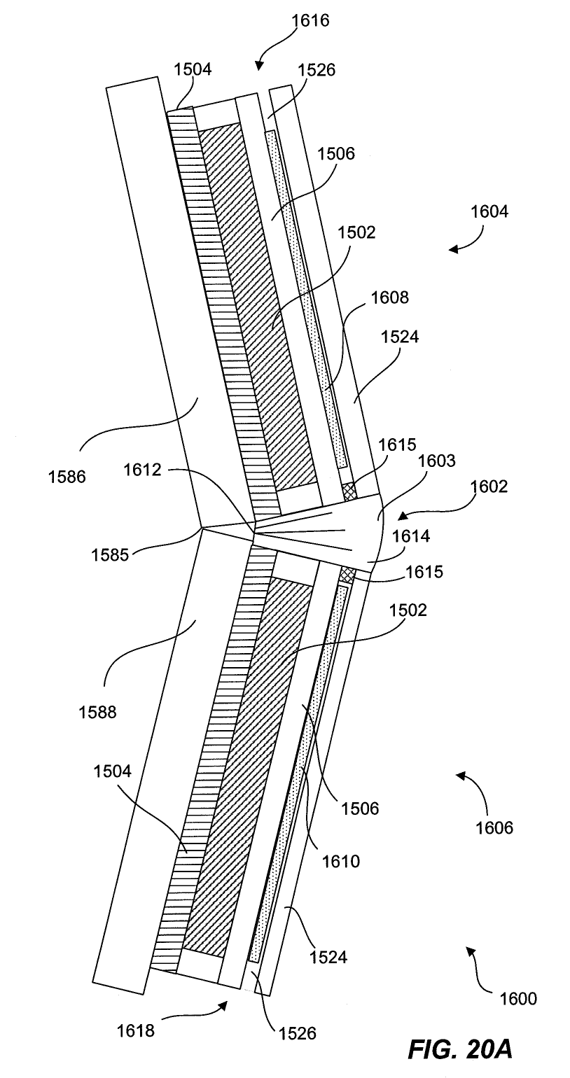

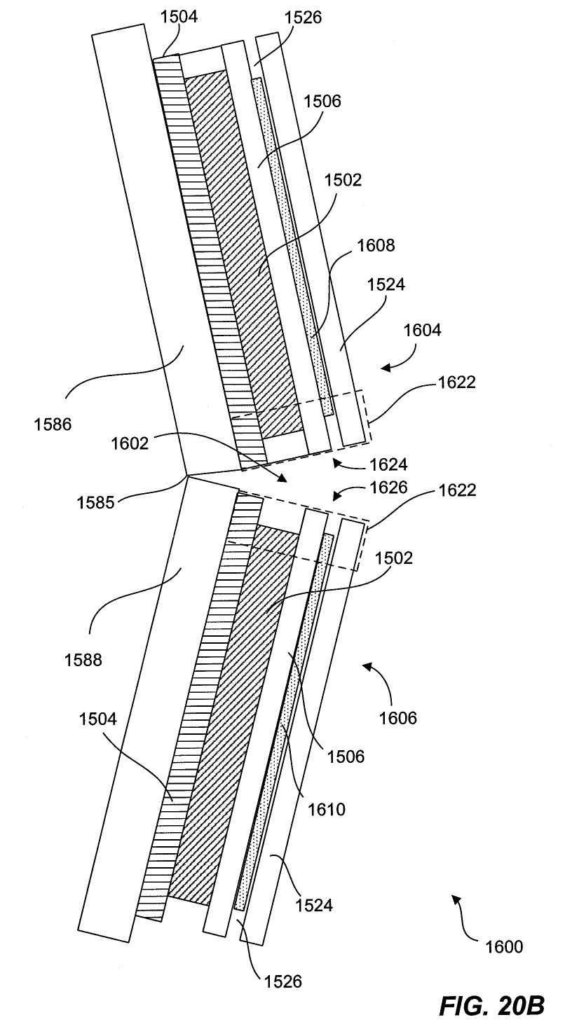

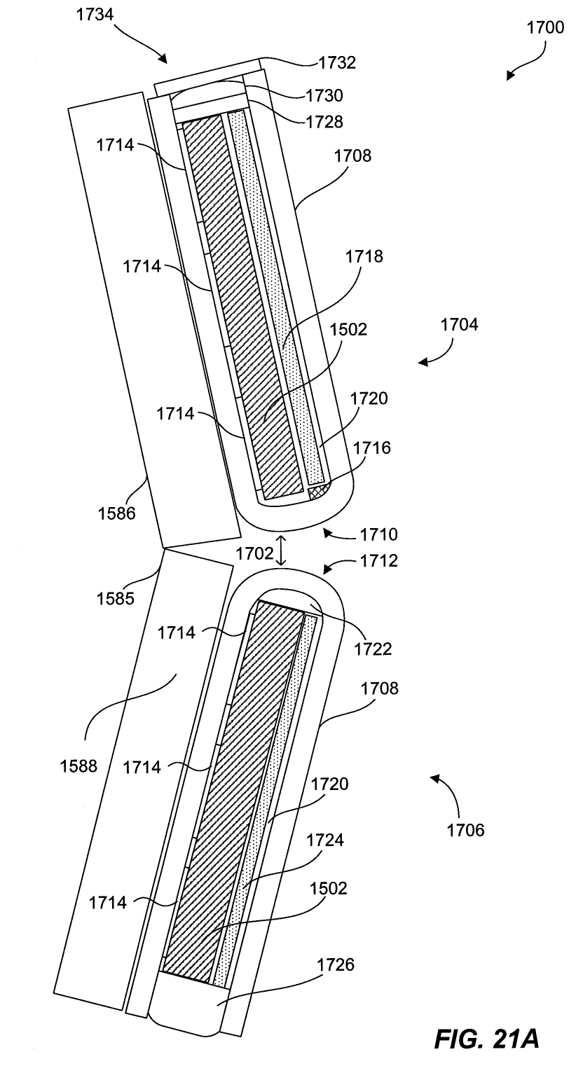

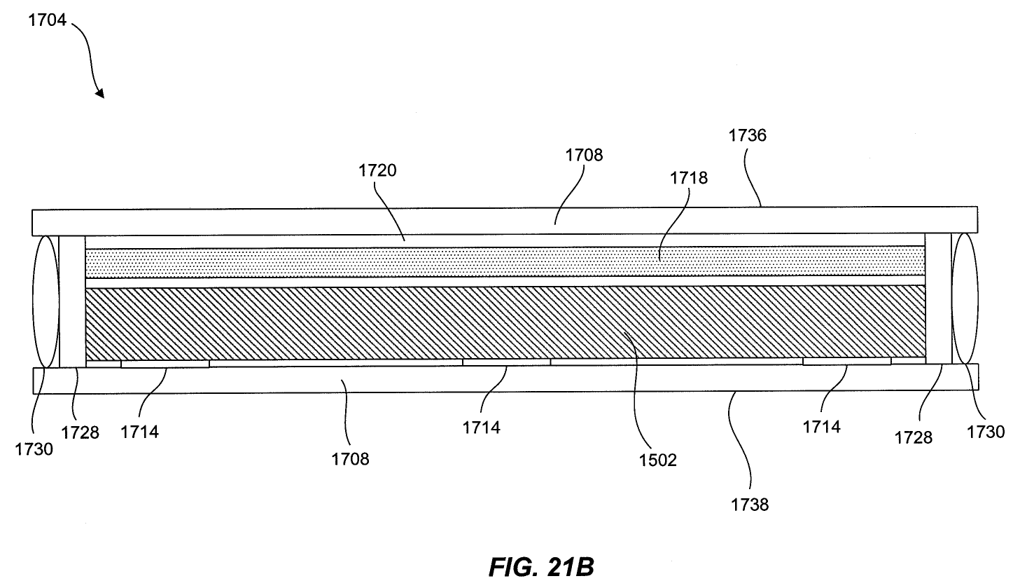

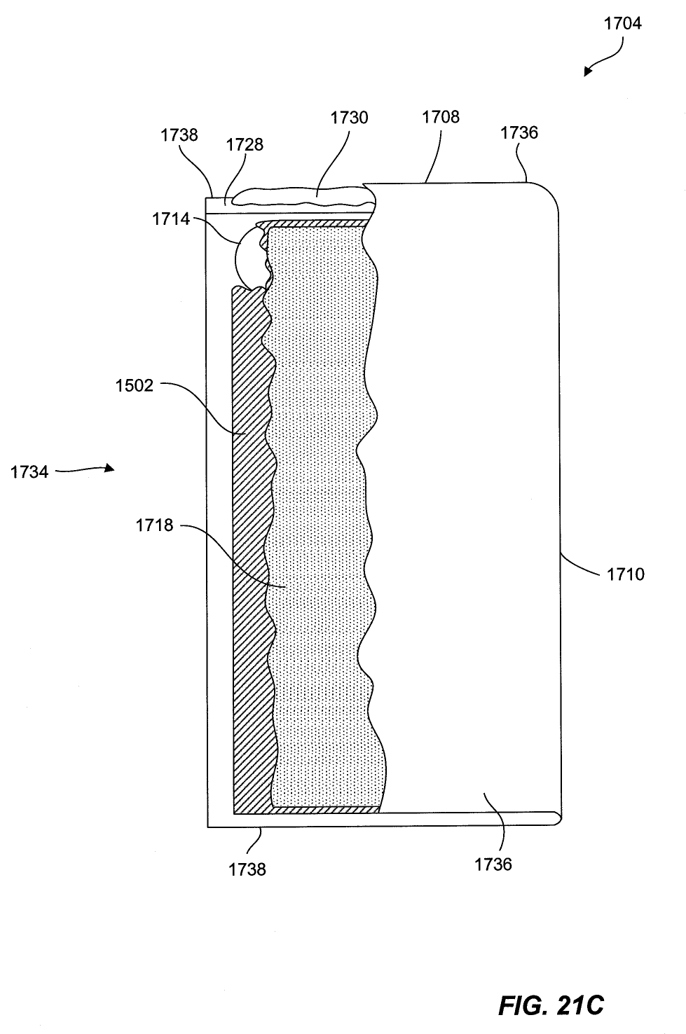

Carriage bolts 1542 are secured at an inner surface 1550 of vehicle panel 1532 (e.g., inside of a trailer), for example with a flat washer 1552 (e.g., steel or aluminum), a locking washer 1554 (e.g., steel or aluminum) and a locking nut 1556 (e.g., steel or aluminum). Liquid thread locker may be applied to carriage bolts 1542 prior to application of locking nut 1556. Likewise, additional hardware such as sheet metal screws, aluminum rivets, stainless steel sheet metal screws and steel elevator bolt(s) may be used in attaching, and securing system 1500 (or system 1600, described below with respect to FIGS. 20-21) to a vehicle. As described below with respect to FIG. 22A, system 1500 may be powered by connecting to an existing vehicle power supply (e.g., a battery), without drilling completely through exterior walls of the vehicle.

System 1500 may also, or alternately, include a framing system 1558 (see FIG. 18). Framing system 1558 is for example a four-sided metal (e.g., aluminum) frame placed around the outer edges of assembled protective panel 1506/backing panel 1504 and related components. Framing system 1558 may be formed with four segments of framing 1538, 1540 (see FIG. 17). Alternately, or additionally, framing system 1558 includes four frame sections 1560, 1562, 1564 and 1566, which may be aluminum Z- or U-shaped panel strips, flat framing strips or other aluminum pieces used to fill gaps or voids and create a flat surface for attachment to door panel 1532, via carriage bolts 1542.

FIG. 18 is a rear view of a vehicle 1570. Vehicle 1570 has left and right door panels 1572, 1574, respectively. System 1500 is shown mounted with left door panel 1572. As shown, an advertisement 1528 and a portion of a backlighting device 1502 below are viewable through protective panel 1506; however, advertisement 1528 may also completely cover device 1502. When powered, device 1502 backlights advertisement 1528 to enhance visibility of advertisement 1528, for example in dim conditions.

In one embodiment, system 1500 has a width W of 12½ to 38 inches and a length L of 20½ to 74 inches. For example, where device 1506 is a 12″×36″ CeeLite™ device, system 1500, including framing system 1558, may be 14″ wide by 38″ long, allowing one inch of framing system 1558 (e.g., section 1560, 1562, 1564 or 1566) at each side. Other exemplary dimensions of device 1502 are given in Table 1, below. It should be noted that differences in width or length between device 1502 and system 1500 are not held to two inches each way (one inch of the appropriate of frame sections 1560, 1562, 1564 or 1556 along each side), but may vary according to framing preferences (e.g., whether a wider or thinner frame is desired around device 1502 and advertisement 1528). Overall dimensions of system 1500 versus device 1502 may also vary depending upon the size of backing panel 1504, protective panel 1506, panel 1524, framing system 1558 and other components. In addition, one or both of light emitting device 1502 and overall display 1500 may be custom cut to desired shapes (e.g., a circle, oval or square) and/or dimensions.

TABLE 1
Light Emitting Device
(width × length, in inches)
Exemplary dimensions of device 1502
16 × 20
20.5 × 20.5
12 × 36
18 × 24
22 × 28
24 × 36
36 × 48
36 × 60
36 × 72

FIG. 19 is a rear view of a display framing system 1600, mounted with a vehicle 1580. Vehicle 1580 has a roll-up door 1582, and system 1600 is sectioned such that a separation 1602 between two sections 1604, 1606 aligns with a division 1585 between two panels 1586, 1588 of door 1582. Section 1604 is sized to fit, or fit within, panel 1586, and section 1606 is sized to fit or fit within panel 1588. In one aspect, sections 1604, 1606 support advertisement assemblies 1608, 1610, respectively, to form one coherent advertisement. A portion (e.g., half) of the subject matter of the coherent advertisement is for example displayed on advertisement assembly 1608, and the remaining portion of the subject matter is displayed on advertisement assembly 1610. In another aspect, advertisement assemblies 1608 and 1610 convey separate advertisements (e.g., two advertisements for separate products, one advertisement and one warning regarding proximity to vehicle 1580, etc.).

Separation 1602 may be bridged by one or more bands of flexible material connecting sections 1604, 1606, such that display framing system 1600 bends at separation 1602 when door panels 1586, 1588 bend during roll-up (opening) of door 1582. Alternately, separation 1602 includes one or more hinged junctions between sections 1604, 1606. In another aspect, sections 1604, 1606 are separately sealed proximate separation 1602 by vinyl, a suitably clear end-cap, cellophane tape or another adhesive. Sections 1604, 1606 are secured with door 1582 via carriage bolts 1542, as described with respect to FIG. 17. Carriage bolts 1542 are for example positioned about every eight inches along the sides of sections 1604, 1606.

FIG. 20A is a simplified side view showing one aspect of system 1600 mounted with panels 1586, 1588 of roll-up door 1582 (FIG. 19). Sections 1604, 1606 are mounted with door panels 1586, 1588 and joined by a band 1603, across separation 1602. Band 1603 is shown as a band of flexible material that folds accordion-style when bent or pinched together at a rear side 1612 and opens or spreads when bent or pulled apart at a front side 1614, for example, as door panels 1586, 1588 separate during roll-up. Band 1603 may be formed with any material that is sufficiently flexible to maintain a connection between sections 1604, 1606 when the sections move, and separation 1602 widens, during roll-up. Band 1603 is for example formed with a translucent or transparent, flexible polymer, with rubber or with other flexible materials. In another aspect (not shown), sections 1604, 1606 hinge together.

Sections 1604, 1606 may include components described with respect to FIGS. 15-18. For example, FIG. 20A shows each section 1604, 1606 having a backing panel 1504 backing a light emitting device 1502, which is in turn protected by a protective panel 1506. A protective panel 1524 is applied over protective panel 1506, leaving a space 1526 for housing advertisement assemblies 1608/1610 (which are similar to advertisement 1528). Although not shown in FIG. 20A for the sake of clarity, fasteners 1508 (see FIGS. 15-16) may be used to secure light emitting device 1502 with backing panel 1504. Adhesive 1514, spacer 1518 (e.g., double-sided tape), caulking 1516 and adhesives 1517, 1527 (e.g., single-sided, waterproof tape) join and seal protective panel 1506 with backing panel 1504, and panel 1506 with protective panel 1524, as described above with respect to FIGS. 15, 16 and/or 17. Fasteners 1534 may be used to position system 1600 with door panels 1586, 1588 prior to securing system 1600, in similar manner as that described with respect to FIG. 17.

As shown in FIG. 20A, a top 1616 of top section 1604 and a bottom 1618 of bottom section 1606 are open between panels 1506 and 1524, in order to accommodate entry of advertising assemblies 1608, 1610, respectively. Spacers 1615 are provided at the bottom of section 1604 and at the top of section 1606, to prevent pinching of advertising assemblies 1608, 1610, for example when sections 1608, 1610 meet as panels 1586 and 1588 join, when roll-up door 1582 closes. Spacers 1615 are for example spacer tape, such as a 1/100″ inch tape.

Once advertising assemblies 1608, 1610 are placed in spaces 1526, additional tape 1527 and/or seals 1529 may be applied to seal advertising assemblies 1608, 1610 within spaces 1526, as shown and described with respect to FIG. 17.

In another aspect, shown in FIG. 20B, sections 1604, 1606 are not joined, and independently mount with door panels 1586, 1588 (respectively). A vinyl tape or other sealant 1622 (depicted as dotted boxes) may be used to seal a bottom 1624 of section 1604 and a top 1626 of section 1606 against moisture or debris. In one aspect, vinyl tape 1622 is wrapped around top 1626 of section 1606 and bottom 1624 of section 1604, as an additional barrier, or in substitution for one or more of the sealing components described herein above (e.g., tapes and/or spacers 1514, 1517, 1518, 1527, caulking 1516, 1516′ and/or seals 1529).

In one embodiment, depicted in FIG. 21A, a display framing system 1700 mounts with roll-up door panels 1586, 1588, such that a separation 1702 exists between a top section 1704 and a bottom section 1706. Top and bottom sections 1704, 1706 each include a protective panel 1708 that wraps around device 1502 (described above) to form an enclosed bottom 1710 of top section 1704, and an enclosed top 1712 of bottom section 1706. Protective panel 1708 is made with Lexan®, Plexiglas® or another material that is semi-flexible, resistant to shock, vibration and impact and at least partially transparent to light. In one aspect, a sheet of Lexan® is heated and bent to form an open-ended pocket for device 1502 and an advertisement (e.g., one of advertising sections 1718, 1724 shown in FIG. 21A).

Device 1502 mounts with protective panel 1708 via fasteners 1714, which are for example ½″ Velcro® disks or tabs (similar to Velcro® 1534, described above) or adhesives. As shown in top section 1704, a spacer 1716, such as a tape or adhesive, is placed within enclosed bottom 1624 formed by protective panel 1708, to prevent pinching of an advertising section 1718 when inserted into an advertising space 1720 formed between device 1502 and protective panel 1708. Alternately, as shown with respect to bottom section 1706, a rubber, silicone or plastic stopper 1722 is positioned with enclosed top 1712, to position one or both of device 1502 and an advertising section 1724. Sections 1704, 1706 are sealed at their open ends with rubber or silicone plug 1726 and/or with one or more of a double-sided tape 1728, caulking 1730 and additional tape or adhesive 1732 (see, e.g., top section 1604, FIG. 20B). Double-sided tape 1728 is for example similar to spacer 1518, caulking 1730 to caulking 1516, and additional tape or adhesive 1732 to additional tape or adhesive 1527.

FIG. 21B is a top view of top section 1704 of system 1700, looking down at a top 1734 of section 1704 shown in FIG. 21A, prior to application of adhesives and caulking. Fasteners 1714 are shown securing device 1502 with protective panel 1708. Protective panel 1708 wraps around device 1502 to form enclosed bottom 1710 (see FIG. 21A), and a first side 1736 and a second side 1738 shown in FIG. 21B. Protective panel 1708 is for example heated and bent to form enclosed bottom 1710 and first and second sides 1736, 1738. Sides 1736, 1738 and enclosed bottom 1710 define advertising space 1720, shown housing advertising section 1718. Top section 1704 is sealed along its sides with one or both of adhesive 1728 and caulking 1730, as described with respect to FIG. 21A. After insertion of advertising section 1718, section 1704 may also be sealed with adhesive 1728, caulking 1730, additional tape or adhesive and/or rubber or silicone plug 1726, as a matter of design preference and to waterproof section 1704.

FIG. 21C is a cut-away (advertising side) view of section 1704, showing device 1502 partially enclosed by protective panel 1708. Protective panel 1708 is for example heated and bent to form enclosed bottom 1710 and sides 1736, 1738. Velcro® tab or disks 1714 are fixed with side 1738, to hold device 1502 in place within folded protective panel 1708. Adhesive 1728 and caulking 1730 bond sides 1736 and 1738, at their edges. After advertising section 1728 is inserted via top 1734, top 1734 is sealed as described with respect to FIG. 21B. In one aspect, a unitary rubber or silicone plug (not shown) fits between sides 1736, 1738 at top 1734, abutting adhesive 1728 and caulking 1730 to protect and waterproof section 1704, device 1502 and advertising section 1718.

Power for lighting light emitting device 1502 may be provided by an independent battery configured with system 1500/1600/1700 or, as shown in FIGS. 23A-27, a power supply of a host vehicle may power system 1500/1600/1700. In one embodiment, wiring from an electrical connection box of a host trailer (which for example forms part of vehicle 1570 or 1580, described above) delivers power to a power inverter of system 1500, 1600 or 1700.

FIG. 22A is a side view of a display framing system 1800. A single system 1800 may mount with a panel of a truck or trailer, or a plurality of systems 1800 may form a combined display upon the panel (e.g., two systems 1800 may be aligned top to bottom to form one combined display, in like manner to top and bottom sections 1704 and 1706 forming a combined display framing system 1700). System 1800 includes a two-dimensional light emitting device 1802 (similar to device 1502, described above) wrapped by a single protective panel 1808. Protective panel 1808 wraps completely around a front 1804, a top 1805 and a bottom 1806, and partially around a back 1807 of device 1802 to form a pocket 1810. Pocket 1810 houses device 1802, an advertisement 1812 and, optionally, additional components. Pocket 1810 opens at opening 1814 proximate back surface 1807 of device 1802. Protective panel 1808 is for example a single sheet of Lexan®, Plexiglas® or another material that is semi-flexible, resistant to shock, vibration and impact and at least partially transparent to light. In one aspect, protective panel 1808 is heated and bent around device 1802, advertisement 1812 and additional components. Advertisement 1812 may represent advertisement 1528 (see, e.g., FIGS. 15-18), advertising assembly 1608 or 1610 (see for example FIGS. 20A-20B) or advertising section 1718 or 1724 (see FIGS. 21A-21C). Additional components include fasteners 1816 (e.g., double-sided tape, other adhesives or Velcro®) for mounting device 1802 with protective panel 1808, and one or more spacers 1818, for positioning one or both of device 1802 and advertisement 1812 within pocket 1810. Spacers 1818 may be segments of single or double-sided adhesive, or discs or tabs of silicone, rubber or another suitable material for holding device 1802 and/or advertisement 1812 securely in place within pocket 1810.

One or more panel mounting segments 1820, formed with or mounted with protective panel 1808, facilitate preliminary mounting of system 1800 with a truck or trailer panel (e.g., a swing-door or roll-up door, as described above). Mounting segments 1820 may be small hooks embedded in the material forming protective panel 1808, for hooking over door panel segments of a roll-up type door. Mounting segments 1820 may alternately be sections of strong adhesive, for sticking protective panel 1808 to a truck or trailer panel, or hook-and-loop fasteners for fitting to complementary hook-and-loop fasteners (e.g., Velcro®) mounted with the truck or trailer panel. For example, mounting segments 1820 may be similar to fasteners 1714 or 1534, described above. Once system 1700 is positioned with the truck or trailer panel, a frame such as framing system 1558 is for example applied around system 1800, for more permanent mounting.

Opening 1814 is sealed and waterproofed with tape 1822. Alternately or additionally, caulking is used to seal opening 1814.

FIG. 22B is a cross-sectional top view of system 1800, taken along line A-A of FIG. 22A. As shown, sides 1824, 1826 of device 1808 are not wrapped by protective panel 1808. In one aspect, protective panel 1808 is laid face-down upon device 1802 and fasteners 1816 are applied to back 1807 of device 1802. Spacers 1818 may be positioned with top 1804 and bottom 1806 (see FIG. 22A). Protective panel 1808 is heated and bent to wrap around front 1804, top 1805 and bottom 1806 of device 1802, and partially around back 1807, leaving opening 1814 (visible in FIG. 22A). The assembly may then be flipped over, to shift back 1807 towards protective panel 1808, opening pocket 1810 (proximate front 1804 of light emitting device 1802) for insertion of advertisement 1812. Alternately, advertisement 1812 may be placed upon protective panel 1808 prior to device 1802 and prior to wrapping or, advertisement 1812 may be inserted into pocket 1810, proximate front 1804 of device 1802, from side 1824 or side 1826.

The sides are then sealed, one permanently and the other removably. For example, as shown, side 1824 is sealed with an adhesive 1828 and a strip of caulking 1830. Adhesive 1828 may be any of the adhesives described herein above. In one aspect, adhesive 1828 is a double-sided, acrylic foam tape with acrylic adhesive. Side 1826 is shown sealed with a removable rubber or silicone seal 1832 (e.g., a strip of rubber or silicone spanning side 1826) beneath a segment of waterproof tape 1834. It will be appreciated that side 1824 may be sealed with adhesive 1828 and caulking 1830 prior to insertion of advertisement 1812 via side 1834.

FIG. 23A is a simplified, exterior front view of a trailer 1900, showing wiring 1902 running from an inverter 1904 for a display framing system (e.g., system 1500, 1600, 1700 or 1800), along the inside of trailer 1900 and into a cavity 1906, for example between an interior floor 1908 and an exterior base 1910 of trailer 1900. Inverter 1904 is shown positioned along a top front corner of trailer 1900; however, inverter 1904 may be positioned elsewhere within trailer 1900 as a matter of design preference. Wiring 1902 enters cavity 1906 via a first hole 1912, and emerges via a second hole 1914, aligned with an existing exterior trailer plug 1916. Trailer plug 1916 serves as an electrical connection between trailer 1900 and a truck that tows trailer 1900 (e.g., a semi truck), and for example transmits power from a power supply to rear lights of trailer 1900. In FIG. 23A, wiring 1902 is illustrated by dotted lines when it is within trailer 1900, and by solid lines when exterior to trailer 1900 (i.e., when it emerges at second hole 1914 along existing trailer plug 1916).

FIG. 23B is a top view, looking down into trailer 1900. Inverter 1904 is shown mounted with a top, front corner of trailer 1900. Wiring 1902, from inverter 1904 to exterior trailer plug 1740, is not shown; however, exterior trailer plug 1916 is visible along the front aspect of trailer 1900. Inverter 1904 is for example a DC to AC electrical inverter that provides electrical current to a light emitting device (e.g., any of devices 1502 or 1802), in order to back-light an advertisement mounted with system 1500, 1600, 1700 or 1800 (see above descriptions). System 1500, 1600, 1700 or 1800 is mounted with a rear door 1917 of trailer 1900.

Wiring 1918 extends from inverter 1904, along a top or side of trailer 1900 and towards the rear of trailer 1900. Wiring 1918 is for example periodically secured (e.g., every 2.5 feet) to a top carrier rail or cross member 1920 of trailer 1900, by rivets or other fasteners. From carrier rail 1920, wiring 1918 extends along the top of trailer 1900 to rear door 1917 to connect with a display framing system (e.g., any of system 1500, 1600, 1700 or 1800) mounted with door 1917. Wiring 1918 for example connects with the display framing system via a hole 1922 through door 1917. Wiring 1918 may be for example a single, three-wire cable including three individual, 22-gauge wires formed of copper or an alloy thereof, which may also be low in component oxygen. In one aspect, two wires conduct current and one wire serves as ground. The wires of wiring 1918 may be individually coated with a protective material rated to about 600 volts, and pressed together to form wiring 1918. Wiring 1918 for example connects with display framing system 1500, 1600, 1700 or 1800 via a three-pin, Molex type connector at one end.

In one embodiment, inverter 1904 is secured to a metal (e.g., steel or aluminum) plate and covered with an enclosure made with steel or another protective material. Inverter 1904 is for example hard wired into existing vehicle electrical circuits using additional wiring, connectors, electrical rubber or vinyl tapes and liquid tapes, which are used to insulate connecting points where two or more wires are linked to transfer electrical power to or from inverter 1904 (in one example, at existing trailer plug 1916). Likewise, wiring 1918, 1902 may be secured within trailer 1900 using known wiring securing devices, tape and the like.

FIG. 23C is a top view, looking down into trailer 1900 and showing wiring 1918 running from inverter 1904, along a side of trailer 1900 and across cross-member 1920. From cross-member 1920, wiring 1918 runs to cross-member 1924. Wiring 1918 is for example secured with cross-members 1920, 1924 by rivets or other fasteners. A spring 1926 connects with wiring 1918 at cross-member 1924. Wiring 1918 is for example secured with spring 1926 at two or more positions, leaving loops of wiring 1918 between connections with spring 1926. Spring 1926 separately connects with rear door 1917 via a cable (not shown), such that spring 1926 stretches when door 1917 is closed and compresses when door 1917 opens. Spring 1926 thus aids in gathering wiring 1918 when it is compressed (and door 1917 is open), to prevent wiring 1918 from sagging deeply within trailer 1900 (e.g., where it could interfere with or be damaged by cargo moving in or out of trailer 1900).

FIG. 23D is a side perspective view of trailer 1900, showing further detail of wiring 1902 and wiring 1918. Wiring 1902 extends from inverter 1904 along a front wall 1928 of trailer 1900, down into cavity 1906, travels proximate trailer plug 1916 and exits trailer 1900 at hole 1914 (better illustrated at FIG. 23A). Wiring 1918 connects with inverter 1904 and is secured along a side wall 1930 of trailer 1900 and a cross-member 1920 spanning the width of trailer 1900. Wiring 1918 may be secured with cross-member 1920 via one or more fasteners 1932. Fasteners 1932 are for example rivets. Wiring 1918 travels along the inner, top surface 1934 of trailer 1900 and along roll-up rear door 1917 to connect with a display framing system, such as system 1500, 1600, 1700 or 1800. In FIG. 22D, roll-up door 1917 is closed.

FIG. 22E shows roll-up door 1917 in an open position, with door 1917 partially rolled into trailer 1900. As shown, fasteners 1932 hold wiring 1918 with sufficient laxity to allow wiring 1918 to sag between fasteners 1932 as door 1917 opens. One or more weights 1936 may be hung on wiring 1918 between fasteners 1932, to aid in drawing wiring 1918 down between fasteners 1932, when door 1917 opens. Fasteners 1932 thus serve as a wire gathering assembly, preventing wiring 1918 from hanging unmanaged within trailer 1900 when door 1917 is open. It will be appreciated that fasteners 1932 may alternately secure one or more springs (e.g., spring 1926, FIG. 23C) with cross-member 1920 in such a manner as to allow the spring or springs to stretch, as discussed above.

FIG. 24 is a simplified rear view of a display framing system 2000, representative of system 1500, 1600, 1700 or 1800, described above. System 2000 is shown mounted with door panels 2002, 2004, which may represent door panels 1586, 1588 of trailer 1580, or door panels of rear, roll-up door 1917, shown in FIGS. 23D and 23E.

As shown in FIG. 24, wiring 2008(1) runs from an inverter 2010 to a lower panel 2012 of display framing system 2000. At a connection point 2014, wiring 2008 splits into sections: 2008(2), which enters lower panel 2012 at an opening 2016, and 2008(3), which enters an upper panel 2018 at an opening 2020. Wiring 2008(2) and 2008(3) for example connect with light emitting devices similar to device 1502 or 1802 (described above) within panels 2012, 2018.

FIG. 25 is a schematic rear view of an inner aspect of a roll-up trailer door 2102. A display framing system 2100 mounts with an outer aspect of door 2102, and is thus shown in dotted outline. System 2100 includes four display sections 2104(1) through 2104(4), and mounts with door 2102 such that two upper display sections 2104(1) and 2104(2) generally align with an upper door panel 2106, while two lower display sections 2104(3) and 2104(4) align with a lower door panel 2108 (with some overlap onto adjacent upper and lower panels). Wiring 2110 extends from a vehicle inverter (not shown) along the inside of door 2102, to a connection point 2112, from which panel wiring 2114A, 2114B branch. Panel wiring 2114(A) connects connection point 2112 to a connection point 2116, from which individual panel wiring 2118(1) and 2118(3) extend to electrically connect with display sections 2104(1) and 2104(3), respectively. Panel wiring 2114(B) runs from connection point 2112 to a connection point 2120, from which individual panel wiring 2118(2) and 2118(4) branch to electrically connect with display sections 2104(2) and 2104(4), respectively. As shown, individual panel wiring 2118 extends through door 2102 to connect with display sections 2104 via openings 2122.

It will be appreciated that four display sections, as shown in FIG. 25, may be incorporated into any of the previously described display framing systems. For example, an outer protective panel, such as panel 1808 or panel 1708, may be bent or molded to individually and partially encase four light emitting devices with advertising spaces, each panel, device and advertising space combination forming one section 2104. Alternately, a protective panel such as panel 1808 or 1708 may be bent or molded to partially encase multiple (e.g., 2) sections 2104. Likewise, each or multiple of sections 2104 may be backed by framing and covered by one or more protective panels, as illustrated with respect to light emitting device 1502, frame 1504 and panels 1506 and 1524, shown in exemplary FIGS. 16-17.

In one aspect, wiring 2118 exits openings 2122 to form electrical connections with light emitting devices formed with each of sections 2104. Wiring 2118 may for example penetrate a frame or a protective panel (e.g., Lexan®, Plexiglas® or another protective material).

FIG. 26 shows one exemplary wiring configuration for connecting a display framing system (e.g., system 1500, 1600, 1700 or 1800, although the wiring configuration may also be used with system 1000 or 1300) with an inverter of a vehicle trailer. As shown in FIG. 26, wiring 2200 extends from an inverter 2202 positioned proximate a front side 2204 of a trailer 2206. Inverter 2202 is for example mounted with the ceiling of trailer 2206 near front side 2204. Wiring 2200 branches at a split 2208 to form a positive bundle 2210 and a negative wire 2212. Split 2208 is shown proximate a roof cross member 2214, and negative wire 2212 may be secured with cross member 2214 to run along the ceiling across trailer 2206. Positive bundle 2210 and negative wire 2212 then meet with a rear door 2216 of trailer 2206, at opposite sides.

As shown in FIG. 27, positive bundle 2210 and negative wire 2212 meet at a connection point 2218 to form wiring 2220. Wiring 2220, through a series of splits and branchings, provides power to a display framing system, such as system 2100, described above with respect to FIG. 25. Hence, wiring, connection points and openings following wiring 2220 are labeled as in FIG. 25. For clarity of illustration, individual sections of system 2100 are not shown in FIG. 25.

FIG. 28 is a flowchart illustrating one display framing method 2800. A light emitting device is placed upon a sheet, in step 2802. In one example of step 2802, device 1502 is placed upon a slightly larger backing panel 1504, leaving a border of about one-half inch or less on all sides of device 1502. Fasteners 1508 (i.e., Velcro® disks) secure the device 1502 to the backing panel 1504. Adhesive is applied to three outer edges of the light emitting device, in step 2804. In one example of step 2804, a double-sided ¼ inch wide, moisture resistant tape serving as adhesive 1514 is placed along three of the outer edges of device 1504.

In step 2806, a first protective panel is fastened over the light emitting device, via the adhesive. In an example of step 2806, protective panel 1506, which is a sheet of clear or frosted Lexan®, or clear Plexiglas®, is pressed onto adhesive 1514. Protective panel 1506 may be sized to approximately match the size of backing panel 1504, such that when panel 1506 is fastened over device 1502, a border of about one-half inch overlaps device 1502 on all sides. The assembly is allowed to set, in step 2808. For example, the assembly may set for 72 hours so that adhesive 1514 firmly adheres device 1502 with protective panel 1506.

Following step 2808, caulking (e.g., latex silicone) is applied between the sheet and the first protective panel, from the adhesive out, on all sides of the assembly that received the adhesive, in step 2804. In one example of step 2810, caulking 1516 is applied from adhesive 1514 to the outer edges of sheet 1504/protective panel 1506 on all sides of device 1506 where adhesive 1514 was used. The assembly is then allowed to set (e.g., for 24 hours) in step 2812, to allow the adhesive and caulking to firmly set up and create a waterproof barrier on the applied sides of the assembly.

In step 2814, the untreated edge is waterproofed. In one example of step 2814, the edge of the assembly that did not receive adhesive or caulking is sealed with a piece of clear, waterproof tape (serving as adhesive 1517), to complete a moisture proof area housing device 1502. In step 2816, a line of adhesive (e.g., double-sided, ½″ wide moisture proof tape) is applied to an upper surface (i.e., opposite the side adhered to the light emitting device) along one or more sides of the first protective panel applied in step 2806. In one example of step 2816, double-sided, ½″ tape acting as spacer 1518 is applied around three edges of the panel 1506, on top surface 1520. In step 2818, a second protective panel, such as Lexan® or Plexiglas®, is secured to the first protective panel, via the adhesive, to create a space for advertising material. In one example of step 2818, protective panel 1524 is applied over spacer 1518, and the thickness of spacer 1518 forms open space 1526. The assembly is again allowed to set, for example for 72 hours, in step 2820. In optional step 2822, caulking is applied between the first and second protective panels on all sides bearing adhesive (e.g., on all taped sides). In one example of step 2822, caulking 1516 is applied between panels 1506, 1524 on all sides bearing adhesive, and one side is left open, in order to accommodate advertising content 1528. Advertising material (e.g. content 1528) is inserted into the space between the first and second panels, in step 2824.

FIG. 29 illustrates a display framing method 2900. A panel is heated, in step 2902, and bent to form an enclosure, in step 2904. Optionally, adhesive is applied along opposing sides of the panel prior to heating, as shown in optional step 2901. In one example of steps 2901, 2902 and 2904, a double-sided tape, serving as adhesive 1728, is applied to a Lexan® panel 1708 proximate opposing panel edges. Panel 1708 is heated and bent to form a rectangular or square-shaped pocket that is enclosed along bottom 1710 or top 1712, first side 1736 and second side 1738, and which is open along one to three edges (see FIGS. 21A-21C). If adhesive 1708 is applied prior to heating and bending panel 1708, either top 1710 or bottom 1712 (whichever was not formed by bending panel 1708) remains open. If optional step 2901 is not carried out prior to heating and bending panel 1708, one of top 1712 and bottom 1712 remains open, along with two opposing edges. See FIG. 21C. A spacer may be inserted, as shown in optional step 2906, and a light emitting device is inserted in step 2908. In one example of steps 2906 and 2908, spacer 1718 is inserted within enclosed bottom 1624 formed by protective panel 1708, to prevent pinching or bunching of an advertisement. Then, light emitting device 1502 is inserted into the enclosure formed by panel 1708, from any of the three open sides. Light emitting device 1502 may first be prepared by applying adhesives 1714, to secure device 1502 with panel 1708.

If optional step 2901 did not occur, adhesive is applied to the panel along two edges of the light emitting device, in optional step 2912. In step 2914, caulking is applied over the adhesive, and the caulking and adhesive are allowed to set. In one example of steps 2910-2914, a double-sided tape serves as adhesive 1728. Adhesive 1728 is inserted between sides 1736 and 1738, proximate device 1502. Caulking 1730 is applied over adhesive 1728, and both the adhesive and caulking are allowed to set for up to about 72 hours. Alternately, though not shown in FIG. 29, adhesive 1728 is allowed to set for up to about 72 hours prior to application of caulking 1730, which is then allowed to set for about an additional 72 hours.

An advertisement is inserted, in step 2916, and the remaining untreated edge of the panel assembly is waterproofed, in step 2918, and allowed to set, in step 2920. In one example of steps 2916-2920, advertising section 1718 is inserted into the enclosure formed by panel 1708, adhesive 1728 and caulking 1730, at the remaining open edge. The panel assembly is then waterproofed by applying a rubber or silicone plug 1726, adhesive 1728, caulking 1730 and/or additional tape to seal the remaining open edge. Optionally, additional tape (e.g., single sided tape) may be applied to all edges of the panel assembly that received adhesive 1728, caulking 1730 or a plug 1726. The assembly is allowed to set for about 72 hours.

FIG. 30 depicts a display framing method 3000. In optional step 3001, an advertisement is placed upon a flat panel, and in step 3002, a light emitting device is placed on the panel. In one example of steps 3001, 3002, advertisement 1812 is placed face-down upon protective panel 1808, which is for example Lexan®. Light emitting device 1802 is placed face-down on panel 1808, atop advertisement 1812, if advertisement 1812 was laid upon panel 1808 in step 3001.

Additional components may be placed with the light emitting device or the panel, in optional step 3004. For example, components such as fasteners 1816 are mounted with the back side 1807 of light emitting device 1802, and spacers 1818 are placed upon panel 1808, proximate light emitting device 1802 and advertisement 1812 (if present), to help hold device 1802 and/or advertisement 1812 in place once the panel is wrapped around device 1802, advertisement 1812 and any additional components.

The panel is heated and wrapped around the light emitting device, in steps 3006 and 3008. Pressure is applied in optional step 3010. In one example of steps 3006-3010, panel 1808 is heated and bent at opposing sides of panel 1808, to enclose front 1804 (laid upon panel 1808 or advertisement 1812, if present), top 1805 and bottom 1806. Panel 1808 ends meet at back 1807 of device 1802, leaving a small opening 1814 proximate back 1807. If fasteners 1816 were mounted with back 1807 (step 3004) of device 1802, or with panel 1808 itself, pressure may be applied to panel 1808 over back 1807, to facilitate contact between fasteners 1816 and panel 1808 (e.g., when fasteners 1816 are sections of double-sided tape or other adhesive), or to facilitate contact between complementary fastener sections disposed with back 1807 and with portions of panel 1808 that meet with back 1807 when panel 1808 is wrapped around device 1082 (e.g., complementary Velcro® sections).

The opening in the panel, proximate the back side of the light emitting device, is sealed in step 3012. In one example of step 3012, opening 1814 is sealed with waterproof tape 1822 and/or caulking, such as caulking 1830. See FIG. 22A). If no advertisement was placed on the panel, in optional step 3001, then an advertisement is inserted into the pocket formed by the panel, in optional step 3014. The panel assembly may be flipped over prior to step 3014, to shift the light emitting device rear-ward, making space for insertion of the advertisement over the light emitting device. For example, panel 1808, housing light emitting device 1802 and any additional components placed at step 3004, is flipped over so that front 1804 of device 1802 shifts away from panel 1808, opening pocket 1810. Advertisement 1812 is then inserted into pocket 1810 from side 1824 or side 1826 (See FIG. 22B).

Open sides of the panel are sealed in step 3016, and the assembly is allowed to set, in step 3020. Optionally, mounting segments are applied to the back of the panel, in step 3018. The panel may be mounted with a vehicle door, and framed, in optional steps 3022 and 3024.

In one example of steps 3016-3024, sides 1824 and 1826 are sealed one permanently and one removably. Side 1824 may be sealed with adhesive 1828 and caulking 1830, while side 1826 is sealed with a removable rubber or silicone seal 1832 and/or a segment of waterproof tape 1834 (or vice versa). It will be appreciated that the side to be permanently sealed may be sealed prior to insertion of advertisement 1812, in step 3014. Once the sides are sealed, mounting segments 1820 (e.g., adhesive or hook and loop fasteners) may be applied to panel 1808 to facilitate temporary mounting of the assembly with a truck or trailer door. The assembly is allowed to set for up to about 72 hours, to cure any adhesives (e.g., adhesive 1828, adhesive fasteners 1816, waterproof tape 1822) and/or caulking (such as caulking 1830). It will be appreciated that additional curing steps may be implemented upon application or activation of adhesives/caulking elsewhere in method 3000, such as following steps 3010 or 3012.

Once the assembly has cured, it may be mounted with a vehicle door, such as roll-up door 1917 (FIGS. 23B-23E). In one aspect, panel 1808 is pressed to door 1917 to contact strong adhesive mounting segments 1820 with door 1917. In another aspect, hook and loop fasteners are applied to door 1917, and panel 1808 is pressed to door 1917 to connect the hook and loop fasteners with complimentary hook and loop fasteners on the back of panel 1808. A frame (e.g., of aluminum, or of different composition) is then applied around panel 1808, to secure panel 1808 to door 1917. For example, framing 1538, 1540 or framing system 1558 is applied to mount panel 1808 with door 1917.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A display framing method, comprising:
assembling a backing panel, a two-dimensional light emitting device, one or more spacers and a protective panel,
to form a display frame having a plurality of edges,
such that the backing panel supports the light emitting device, and
such that the one or more spacers define a space between the light emitting device and the protective panel; and
sealing all but one unsealed edge adjoining the space, wherein the unsealed edge allows access to the space.

2. The method of claim 1, the protective panel being a first protective panel, the method further comprising assembling a second protective panel between the light emitting device and the space.

3. The method of claim 2, assembling comprising utilizing double-sided tape as at least one of the one or more spacers to attach the second protective panel to the first protective panel.

4. The method of claim 1, further comprising inserting at least partially translucent advertising material into the space through the unsealed edge such that the light emitting device backlights the advertising material.

5. The method of claim 4, further comprising sealing the unsealed edge with the advertising material in the space.

6. The method of claim 5, wherein sealing the unsealed edge comprises utilizing one or more of caulk, a rubber plug and a silicone plug.

7. The method of claim 1, sealing comprising applying caulk to one or more of the edges.

8. The method of claim 7, further comprising setting the caulk.

9. The method of claim 1, assembling comprising bending a panel of substantially transparent material approximately in half to form the backing panel and the protective panel.

10. The method of claim 1, assembling comprising attaching the light emitting device to the backing panel with double-sided tape.

11. The method of claim 1, further comprising mounting the display frame to a vehicle.

12. The method of claim 11, further comprising powering the light emitting device from a power supply of the vehicle.

13. A display framing system, comprising:
a two-dimensional light emitting device;
a backing panel that supports the light emitting device;
a protective panel; and
one or more spacers that define a space between the light emitting device and the protective panel, the light emitting device, the backing panel, and the protective panel aligned to form a plurality of edges; and
one or more sealants that seal all but an unsealed one of the edges, such that advertising material may be inserted into the space through the unsealed edge.

14. The system of claim 13, the protective panel being a first protective panel, the system further comprising a second protective panel between the light emitting device and the space.

15. The system of claim 13, at least one of the one or more spacers comprising double-sided tape that attaches the second protective panel to the first protective panel.

16. The system of claim 13, further comprising at least partially translucent advertising material inserted through the unsealed edge into the space, such that the light emitting device backlights the advertising material.

17. The system of claim 16, further comprising a sealant that seals the unsealed edge with the advertising material in the space.

18. The system of claim 17, the sealant that seals the unsealed edge comprising one or more of caulk, a rubber plug and a silicone plug.

19. The system of claim 13, the sealant comprising caulk.

20. The system of claim 13, the backing panel and the first protective panel being formed by bending a panel approximately in half.

21. The system of claim 13, further comprising hardware for mounting the system to a vehicle.

22. The system of claim 13, further comprising wiring for powering the light emitting device from a power supply of the vehicle.
